(19) United States
(12) Patent Application Publication
(10) Pub. No.: US 2026/0136310 A1
(43) Pub. Date: May 14, 2026

(54) SYNCHRONIZATION SIGNAL BLOCK TRANSMISSION WITH MULTIPLE DIGITAL PRECODERS

(71) Applicant: QUALCOMM Incorporated, San Diego, CA (US)

(72) Inventors: In-Soo KIM, San Diego, CA (US); Yan ZHOU, San Diego, CA (US); Jing SUN, San Diego, CA (US); Jing JIANG, San Diego, CA (US)

(21) Appl. No.: 18/943,195

(22) Filed: Nov. 11, 2024

(51) Int. Cl. H04W 56/00; H04W 72/1268; H04W 74/0833

(52) U.S. Cl. CPC H04W 56/0015; H04W 72/1268; H04W 74/0833

(57) ABSTRACT

Various aspects of the present disclosure generally relate to wireless communication. Some aspects relate generally to signaling of frequency-division multiplexed (FDMed) synchronization signal blocks (SSBs) using different precoders. This signaling may support selection of a digital precoder based on multiple SSBs. Some aspects more specifically provide frequency-division multiplexing of multiple SSBs, where each of the multiple SSBs is transmitted with a respective different digital precoder. For example, a network entity may transmit SSBs with varying digital precoders in both the time domain and the frequency domain. In some aspects, the network entity may transmit the SSBs in accordance with a pattern that indicates specific digital precoders associated with each SSB of an SSB transmission. A UE may receive and measure one or more SSBs of the SSB transmission. The UE may select a digital precoder and signal information indicating the selected digital precoder.

### FIELD OF THE DISCLOSURE

Aspects of the present disclosure generally relate to wireless communication and specifically relate to techniques, apparatuses, and methods associated with synchronization signal block transmission with multiple digital precoders.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

In certain wireless communications systems, such as 5G New Radio systems and/or future wireless communications systems, a user equipment (UE) may scan for certain broadcast signals to establish a communication link with a network entity. For example, during initial cell acquisition, a UE may scan certain frequency resources for broadcast signals that carry synchronization information, such as a synchronization signal block (SSB). In some cases, an SSB is referred to as a synchronization signal/physical broadcast channel block. An SSB may contain at least one of a primary synchronization signal (PSS), a secondary synchronization signal (SSS), or a physical broadcast channel (PBCH). The PSS and SSS may be used by the UE for synchronization, cell search, and measurement. The PBCH may carry a master information block (MIB), which indicates the location of a control resource set zero (CORESET #0). The CORESET #0 may indicate a possible transmission location of a remaining minimum system information (RMSI) physical downlink control channel (PDCCH). The RMSI PDCCH may carry downlink control information that schedules another transmission, such as a system information block (SIB) transmission of SIB1.

A wireless communication system may support communication in various frequency ranges. Higher frequency ranges (that is, frequency ranges that use higher-frequency signals to communicate) may provide higher throughput but may be associated with more attenuation than lower frequency ranges. Thus, communications in higher frequency ranges may benefit from beamforming. Beamforming can be performed in the analog domain, the digital domain, or both. Analog beamforming involves adjusting phase and amplitude of different antenna elements of an antenna array using analog hardware. In analog beamforming, a same signal may be fed to each antenna element for transmission, and analog phase-shifters may be used to steer the transmitted signal. Digital beamforming involves mapping a signal (such as an SSB) to a set of antenna ports of the antenna array. For example, a signal may be precoded using a digital precoder in the baseband domain before radio frequency transmission. The digital precoder may specify a set of amplitude and phase modifications for the signal before the signal is converted to the radio frequency domain.

### SUMMARY

Certain aspects provide a method for wireless communications by a user equipment (UE). The method includes receiving a synchronization signal block (SSB) transmission that includes a first SSB associated with a first digital precoder and a second SSB, at least partially overlapped in time with the first SSB, associated with a second digital precoder; performing a measurement on the SSB transmission; and transmitting an indication of a selected digital precoder of the first digital precoder or the second digital precoder, wherein the selected digital precoder is in accordance with the measurement.

Certain aspects provide a method for wireless communications by a network entity. The method includes transmitting a SSB transmission that includes a first SSB associated with a first digital precoder and a second SSB, at least partially overlapped in time with the first SSB, associated with a second digital precoder; receiving an indication of a selected digital precoder of the first digital precoder or the second digital precoder; and communicating using the selected digital precoder.

Certain aspects provide an apparatus for wireless communications. The apparatus includes a processing system that includes one or more processors and one or more memories coupled with the one or more processors, the processing system configured to cause a UE to: receive a SSB transmission that includes a first SSB associated with a first digital precoder and a second SSB, at least partially overlapped in time with the first SSB, associated with a second digital precoder; perform a measurement on the SSB transmission; and transmit an indication of a selected digital precoder of the first digital precoder or the second digital precoder, wherein the selected digital precoder is in accordance with the measurement.

Certain aspects provide an apparatus for wireless communications. The apparatus includes a processing system that includes one or more processors and one or more memories coupled with the one or more processors, the processing system configured to cause a network entity to: transmit a synchronization signal block (SSB) transmission that includes a first SSB associated with a first digital precoder and a second SSB, at least partially overlapped in time with the first SSB, associated with a second digital precoder; receive an indication of a selected digital precoder of the first digital precoder or the second digital precoder; and communicate using the selected digital precoder.

Certain aspects provide one or more non-transitory computer-readable media. The one or more non-transitory computer-readable media includes executable instructions that, when executed by one more processors of an apparatus, cause the apparatus to receive a SSB transmission that includes a first SSB associated with a first digital precoder and a second SSB, at least partially overlapped in time with the first SSB, associated with a second digital precoder; perform a measurement on the SSB transmission; and transmit an indication of a selected digital precoder of the first digital precoder or the second digital precoder, wherein the selected digital precoder is in accordance with the measurement.

Certain aspects provide one or more non-transitory computer-readable media. The one or more non-transitory computer-readable media includes executable instructions that, when executed by one more processors of an apparatus, cause the apparatus to transmit a SSB transmission that includes a first SSB associated with a first digital precoder and a second SSB, at least partially overlapped in time with the first SSB, associated with a second digital precoder; receive an indication of a selected digital precoder of the first digital precoder or the second digital precoder; and communicate using the selected digital precoder.

Certain aspects provide an apparatus for wireless communications. The apparatus includes means for receiving a SSB transmission that includes a first SSB associated with a first digital precoder and a second SSB, at least partially overlapped in time with the first SSB, associated with a second digital precoder; means for performing a measurement on the SSB transmission; and means for transmitting an indication of a selected digital precoder of the first digital precoder or the second digital precoder, wherein the selected digital precoder is in accordance with the measurement.

Certain aspects provide an apparatus for wireless communications. The apparatus includes means for transmitting a SSB transmission that includes a first SSB associated with a first digital precoder and a second SSB, at least partially overlapped in time with the first SSB, associated with a second digital precoder; means for receiving an indication of a selected digital precoder of the first digital precoder or the second digital precoder; and means for communicating using the selected digital precoder.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network.

FIG. 2 is a diagram illustrating an example disaggregated network entity architecture.

FIG. 3 depicts aspects of network entities and a user equipment (UE).

FIGS. 4A and 4B depict process flow diagrams of example random access channel (RACH) procedures.

FIG. 5 illustrates an example synchronization signal block (SSB).

FIG. 6 is a diagram illustrating an example of time-division multiplexed (TDMed) SSBs belonging to synchronization signal (SS) bursts.

FIG. 7 is a diagram illustrating an example of TDMed and frequency division multiplexed (FDMed) SSBs belonging to SS bursts.

FIG. 8 is a diagram illustrating an example of validity or invalidity of an SSB according to a synchronization raster.

FIG. 9 is a diagram illustrating an example of indication of a location of a control resource set zero (CORESET #0) for FDMed SSBs.

FIG. 10 is a diagram illustrating an example of SSBs that are each associated with one or more RACH occasions (ROs) and digital precoders.

FIG. 11 is a diagram illustrating an example of measurements on multiple FDMed and TDMed SSBs.

FIG. 12 is a diagram illustrating an example of signaling for FDMed SSB transmission with multiple digital precoders.

FIG. 13 is a diagram illustrating an example of indication of a selected digital precoder during a RACH procedure.

FIG. 14 shows a process for wireless communications by an apparatus.

FIG. 15 shows a process for wireless communications by an apparatus.

FIG. 16 depicts aspects of an example communications device configured for wireless communications.

FIG. 17 depicts aspects of an example communications device configured for wireless communications.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

As mentioned, some wireless communication systems may support beamforming to improve throughput and gain in high-attenuation scenarios such as higher-frequency-range communication. A wireless communication device may use an antenna array that includes a number of antenna elements. A signal to be transmitted can be manipulated in the digital domain (at the baseband processing stage), the analog domain (such as by analog phase-shifters after the signal is converted to the radio frequency domain), or both. Analog beamforming may provide steering of a single beam. For example, a given antenna array may be incapable of forming two different analog beams, since analog beamforming involves providing a signal to each of multiple antenna elements of the antenna array and manipulating phase or amplitude at or in connection with each of the multiple antenna elements. Digital beamforming may support multiple concurrent beams (such as in the context of multi-user multiple-input multiple-output (MU-MIMO) communication). For example, in digital beamforming, a digital precoder may indicate a mapping of a signal to a set of antenna ports, a set of phase or amplitude modifications to be applied to the signal, or a combination thereof. More specifically, the digital precoder may map each layer of a signal to a set of transmit-receive units (TxRUs) by adjusting phase and amplitude of the signal.

A network entity may transmit a synchronization signal block (SSB) to support various operations in a wireless communications network, such as synchronization, cell search, measurement, or beam selection. An SSB may be transmitted as part of a synchronization signal (SS) burst, which may include multiple SSBs that are distributed in time. The SS burst may allow for beamsweeping in the analog domain. “Beamsweeping” refers to the transmission of multiple signals (in this case, multiple SSBs of one or more SS bursts) where each signal is transmitted with a respective different configuration. For example, a first SSB of an SS burst may be transmitted with a first analog beam configuration, a second SSB of the SSB burst may be transmitted with a second analog beam configuration, and so on.

A network entity may be equipped with two or more antenna ports, since the network entity may use cross-polarized antenna elements. In some deployments, a digital precoder used by a network entity, such as a digital precoder that maps an SSB to multiple antenna ports, may be fixed to a predefined configuration. This may simplify implementation, but may lead to sub-optimal beamforming performance. For example, conditions associated with the network entity may change such that the predefined digital precoder provides lower gain than another digital precoder that the network entity is capable of using. It may be beneficial to identify a suitable (such as best or optimal, or that provides at least a threshold performance) digital precoder for communication between a UE and a network entity. One way to identify a suitable digital precoder is to perform beamsweeping over time-domain SSB transmissions (similar to how beamsweeping is performed for analog beamforming), such that the UE can measure different SSB transmissions at different times and select an appropriate digital precoder. However, time-domain beamsweeping is associated with latency, and this may delay or impede operations performed using the SSB, such as synchronization, cell search, measurement, and beam selection.

Aspects of the present disclosure relate generally to selection of a digital precoder based on multiple SSBs. Some aspects more specifically provide frequency-division multiplexing of multiple SSBs, where each of the multiple SSBs is transmitted with a respective different digital precoder. For example, a network entity may transmit SSBs with varying digital precoders in both the time domain and the frequency domain. In some aspects, the network entity may transmit the SSBs in accordance with a pattern that indicates specific digital precoders associated with each SSB of an SSB transmission. A UE may receive and measure one or more SSBs of the SSB transmission. The UE may select a digital precoder from one or more digital precoders corresponding to the one or more SSBs. The UE may signal information indicating the selected digital precoder, such as via a random access channel (RACH) transmission. Some aspects of the present disclosure define approaches for signaling information regarding the SSB transmission described above in a measurement report. For example, aspects described herein may define how to report measurements on SSBs that are frequency-division multiplexed (and optionally also time-division multiplexed), digital precoders associated with the SSBs, or other information.

Aspects of the present disclosure may be used to realize one or more of the following potential advantages. In some aspects, by transmitting or receiving multiple SSBs with different digital precoders that are multiplexed in the frequency domain, aspects described herein provide for identification and signaling of a suitable (such as best, optimal, or satisfactory) digital precoder based on measuring the multiple SSBs. By multiplexing the multiple SSBs in the frequency domain, latency of digital precoder selection is reduced relative to only multiplexing SSBs in the time domain. By multiplexing the multiple SSBs in both the frequency domain and the time domain, latency of digital precoder selection is further reduced, and the number of selectable digital precoders can be increased. By transmitting the SSBs in accordance with a digital precoder pattern, mutual understanding of a relationship between SSBs and digital precoders is achieved, thereby enabling or improving selection and reporting of selected digital precoders. By defining how to report measurements on SSBs that are frequency-division multiplexed (and optionally also time-division multiplexed), aspects described herein clarify measurement reporting (such as for neighbor cells) when SSBs are frequency-division multiplexed, thereby resolving ambiguity regarding which SSBs are to be measured and reported.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

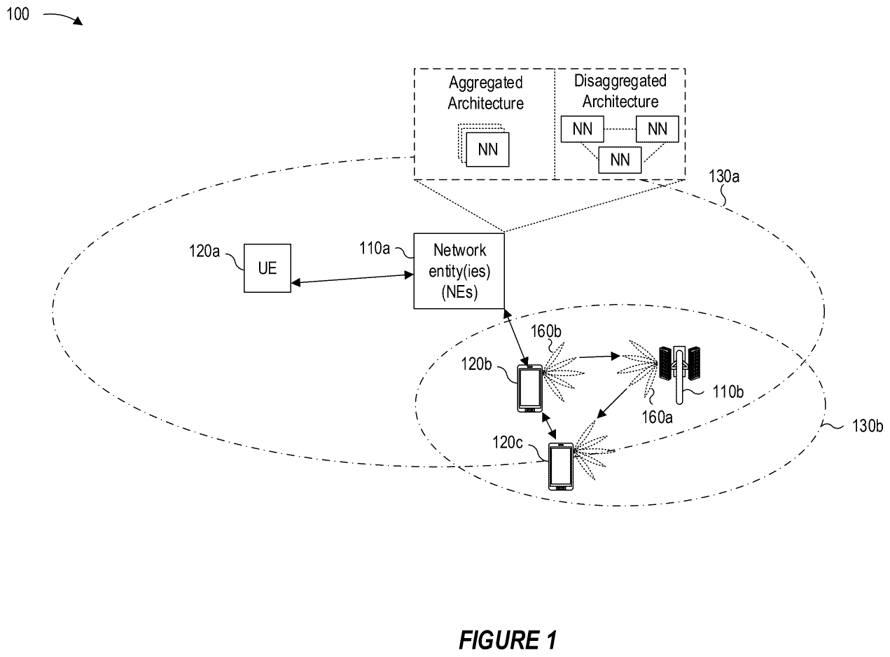

FIG. 1 is a diagram illustrating an example of a wireless communication network 100. The wireless communication network 100 may be or may include elements of a 5G (or NR) network or a 6G network, among other examples. The wireless communication network 100 may include multiple network entities 110. For example, in FIG. 1, the wireless communication network 100 includes a network entity (NE) 110a and a network entity 110b. The network entities 110 may support communications with multiple UEs 120. For example, in FIG. 1, the network entities 110 support communication with a UE 120a, a UE 120b, and a UE 120c. In some examples, a UE 120 may also communicate with other UEs 120 and a network entity 110 may communicate with a core network and with other network entities 110.

The network entities 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHZ,” if used herein, may broadly refer to frequencies that are less than 6 GHZ, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network entity 110 may be, may include, or may also be referred to as an NR network entity, a 5G network entity, a 6G network entity, a Node B, a gNB, an access point (AP), a transmission reception point (TRP), a network entity, a network element, a network equipment, and/or another type of device, component, or system included in a RAN. In various deployments, a network entity 110 may be implemented as a single physical node (for example, a single physical structure) or may be implemented as two or more physical nodes (for example, two or more distinct physical structures). For example, a network entity 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network entity 110 may be an aggregated network entity having an aggregated architecture, meaning that the network entity 110 may implement a full radio protocol stack that is physically and logically integrated within a single physical structure in the wireless communication network 100. For example, an aggregated network entity 110 may consist of a single standalone base station or a single TRP that operates with a full radio protocol stack to enable or facilitate communication between a UE 120 and a core network of the wireless communication network 100.

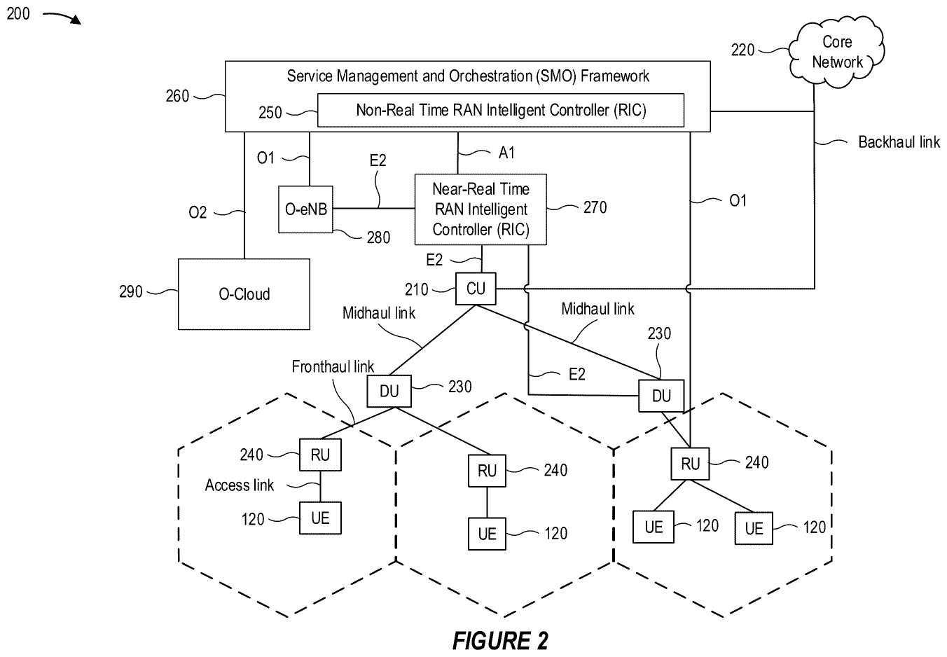

Alternatively, and as also shown, a network entity 110 may be a disaggregated network entity (sometimes referred to as a disaggregated base station), having a disaggregated architecture, meaning that the network entity 110 may operate with a radio protocol stack that is physically distributed and/or logically distributed among two or more nodes in the same geographic location or in different geographic locations. An example disaggregated network entity architecture is described in more detail below with reference to FIG. 2. In some deployments, disaggregated network entities 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network entities 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network entity 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network entities 110 (for example, a base station, an RU, or a TRP) may provide communication coverage for a particular geographic area. The term “cell” can refer to a coverage area of a network entity 110 or to a network entity 110 itself, depending on the context in which the term is used. A network entity 110 may support one or more cells (for example, each cell may support communication within an angular (for example, 60 degree) range around the network entity). In some examples, a network entity 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network entity 110 (for example, a train, a satellite, an unmanned aerial vehicle, or an NTN network entity).

The wireless communication network 100 may be a heterogeneous network that includes network entities 110 of different types, such as macro network entities, pico network entities, femto network entities, relay network entities, aggregated network entities, and/or disaggregated network entities, among other examples. Various different types of network entities 110 may generally transmit at different power levels, serve different coverage areas (for example, a cell 130a and a cell 130b), and/or have different impacts on interference in the wireless communication network 100 than other types of network entities 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, smart jewelry, a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network entity, and/or any other suitable device or function that may communicate via a wireless medium.

In some examples, a network entity 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network entity 110 to a UE 120, and “uplink” (or “UL”) refers to a communication direction from a UE 120 to a network entity 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

In some examples, a UE 120 and a network entity 110 may perform MIMO communication “MIMO” generally refers to transmitting or receiving multiple signals (such as multiple layers or multiple data streams) simultaneously over the same time and frequency resources. MIMO techniques generally exploit multipath propagation. A network entity 110 or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network entity 110b may generate one or more beams 160a and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network entity 110 and/or at the UE 120, such as in a network implementing mmWave technology. Massive MIMO may improve communication reliability by enabling a network entity 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

FIG. 2 is a diagram illustrating an example disaggregated network entity architecture 200. One or more components of the example disaggregated network entity architecture 200 may be, may include, or may be included in one or more network entities (such one or more network entities 110). The disaggregated network entity architecture 200 may include a CU 210 that can communicate directly with a core network 220 via a backhaul link, or that can communicate indirectly with the core network 220 via one or more disaggregated control units, such as a Non-RT RAN intelligent controller (RIC) 250 associated with a Service Management and Orchestration (SMO) Framework 260 and/or a Near-RT RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network entity architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, artificial intelligence or machine learning (AI/ML) workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

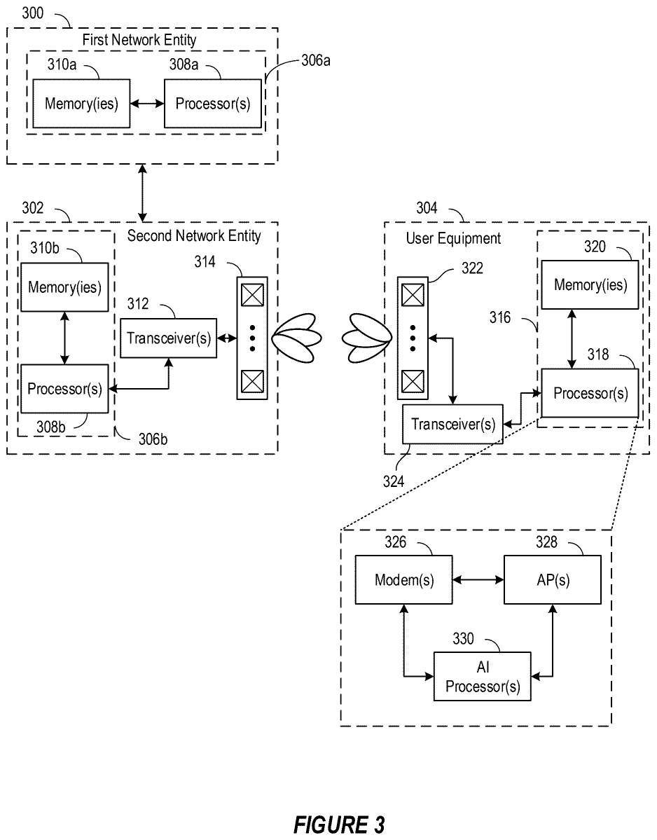

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (for example, network entity 110). For example, first network entity 300 and second network entity 302 may be co-located. In some other examples, first network entity 300 may be implemented separately from second network entity 302. For example, first network entity 300 may be implemented as a function (for example, one or more processes) running on a server, such as in a cloud (for example, a public or private cloud). As another example, first network entity 300 may be implemented as a virtual computing instance (for example, virtual machine or container) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (for example, radio, air interface) communication with other devices such as UE 304. The one or more transceivers 312 may include one or more radio frequency (RF) components, such as an RF transceiver, a front-end module (for example, an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3. The term “antenna module” may refer to circuitry including one or more antennas as well as one or more other components (such as filters, amplifiers, or processors) associated with integrating the antenna module into a wireless communication device such as the network entity 300 or 302 or the UE 304.

UE 304 may be an example of UE 120. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (for example, via modulation) and/or converts the waveform of a received signal into information (for example, via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (for example, for transmissions) or a data sink (for example, for receptions).

The one or more transceivers 324 may perform processing related to implementing physical layer (for example, radio, air interface) communication with other devices such as other UEs 304 or second network entity 302. The one or more transceivers 324 may include one or more RF components, such as an RF transceiver, a front-end module (for example, an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (for example, a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (for example, a transmit processor) may process (for example, encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (for example, a TX MIMO processor) may perform spatial processing (for example, precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (for example, convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (for example, filter, amplify, downconvert, and digitize) the received signals to obtain input samples. The one or more transceivers 324 and/or the processing system 316 may further process the input samples to obtain received symbols.

The processing system 316 (for example, modem 326, an RX MIMO detector) may obtain the received symbols, perform MIMO detection on the received symbols if applicable, and provide detected symbols. The processing system 316 (for example, a modem 326, a receive processor) may process (for example, de-interleave and decode) the detected symbols. The processing system 316 may provide decoded data for the UE 304 (for example, to an AP 328) and/or decoded control information (for example, to a controller/processor of the processing system 316).

For an example uplink transmission or a sidelink transmission from UE 304, the processing system 316 (for example, modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (for example, a modem 326, the transmit processor) may also generate reference symbols for a reference signal (for example, for a sounding reference signal (SRS), a demodulation reference signal, a phase tracking reference signal, or the like). In some examples, the symbols and/or reference signals may be precoded by the processing system 316 (for example, modem 326, a TX MIMO processor), further processed by the one or more transceivers 324 (for example, for single carrier frequency division multiplexing (SC-FDM)), and transmitted to second network entity 302.

At second network entity 302, the uplink signals from UE 304 may be received by the one or more antennas 314, conditioned by the one or more transceivers 312 (for example, filtered, amplified, downconverted, and digitized), detected (for example, by the processing system 306b such as a modem and/or an RX MIMO detector), and further processed by the processing system 306b (for example, a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, network entity 110, UE 120, or UE 304, may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). Some aspects and techniques as described herein may be implemented, at least in part, using an AI program (for example, referred to herein as an “AI/ML model”), such as a program that includes a machine learning (ML) model and/or an artificial neural network (ANN) model. The AI/ML model may be deployed at a device (for example, a network entity 300 or 302, a UE 304, an AI/ML server). For example, the AI/ML model may be deployed at a UE 304 (for example, the processing system 316), a network entity 110 (for example, the processing system 306), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 304 and a second portion of the AI/ML model may be deployed at a network entity 300 or 302). In other examples, a first AI/ML model may be deployed at a UE 304 and a second AI/ML model may be deployed at a network entity 300 or 302. The AI/ML model(s) may be configured to enhance various aspects of wireless communication. For example, the AI/ML model(s) may be trained to identify patterns or relationships in data corresponding to the wireless communication, a device, and/or an air interface, among other examples. The AI/ML model(s) may support operational decisions relating to one or more aspects associated with wireless communications devices, networks, or services.

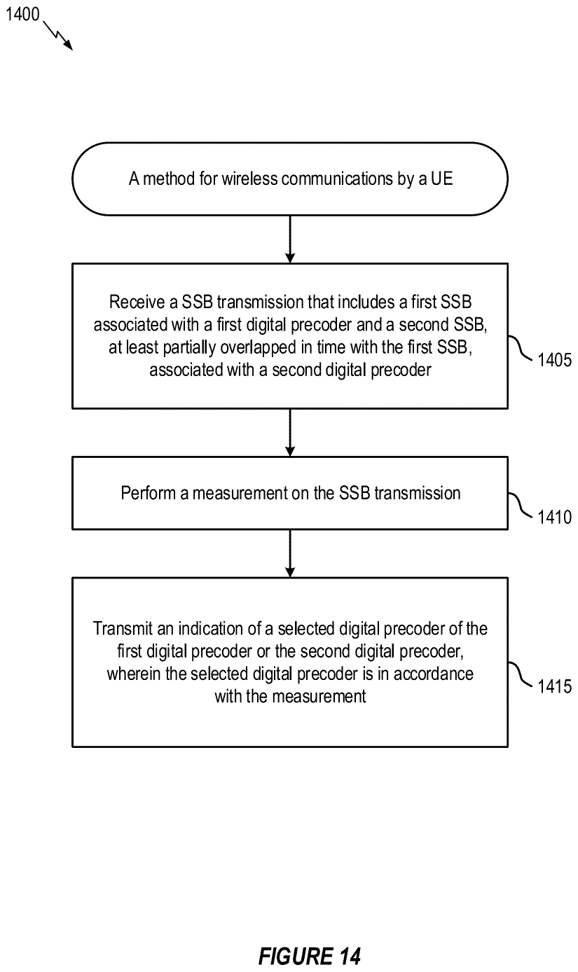

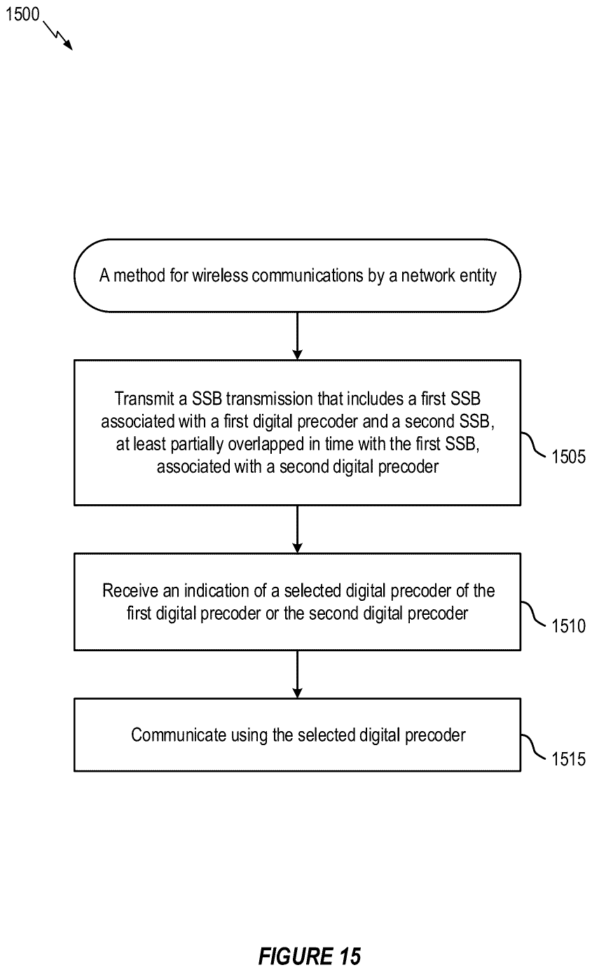

The network entity 110, the UE 120, the CU 210, the DU 230, the RU 240, the network entity 300 or 302, the processing system 306, the UE 304, the processing system 316, or any other component(s) of FIGS. 1, 2, and/or 3 may implement one or more techniques or perform one or more operations associated with synchronization signal block transmission with multiple digital precoders, as described in more detail elsewhere herein. For example, the network entity 110, network entity 300, or network entity 302 (collectively, “network entity 110/300/302”), the UE 120 or UE 304 (collectively, “UE 120/304”), the CU 210, the DU 230, the RU 240, the processing system 306, or the processing system 316 may perform or direct operations of, for example, process 1400 of FIG. 14, process 1500 of FIG. 15, or other processes as described herein (alone or in conjunction with one or more other processors). Memory of the network entity 110/300/302 may store data and program code (or instructions) for the network entity 110/300/302, the CU 210, the DU 230, or the RU 240. In some examples, the memory of the network entity 110/300/302 may store data relating to a UE 120/304, such as RRC state information or a UE context. Memory of the UE 120/304 may store data and program code (or instructions) for the UE 120/304, such as context information. In some examples, the memory of the UE 120/304 or the memory of the network entity 110/300/302 may include a non-transitory computer-readable medium storing a set of instructions for wireless communication. For example, the set of instructions, when executed by one or more processors (for example, the one or more processors 308 or the one or more processors 318) of the network entity 110/300/302, the UE 120/304, the CU 210, the DU 230, or the RU 240, may cause the one or more processors to perform process 1400 of FIG. 14, process 1500 of FIG. 15, or other processes as described herein. In some examples, executing instructions may include running the instructions, converting the instructions, compiling the instructions, and/or interpreting the instructions, among other examples.

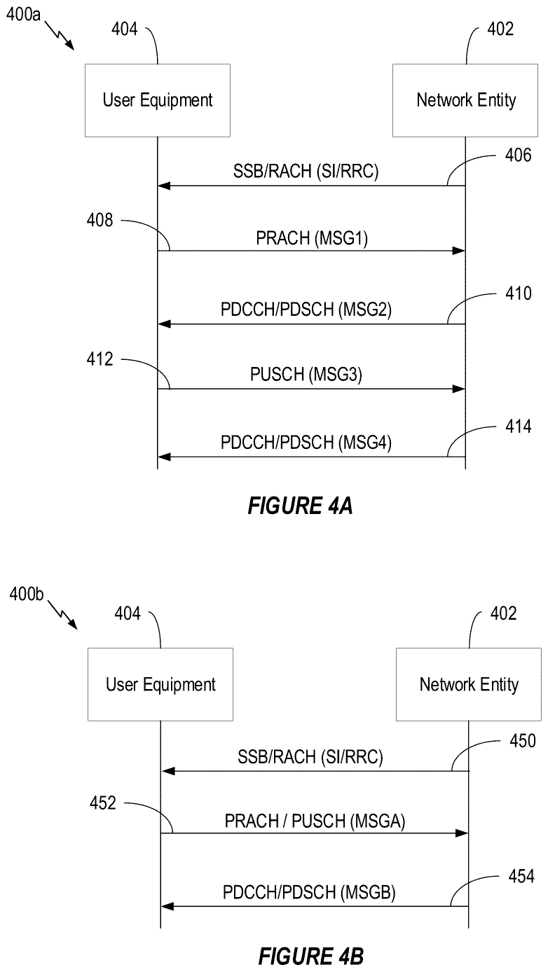

FIG. 4A depicts a process flow diagram of an example four-step RACH procedure 400a performed between a UE 404 and a network entity 402. In some aspects, the UE 404 is the UE 120 depicted and described with respect to FIG. 1 or the UE 304 depicted and described with respect to FIG. 3. In some aspects, the network entity 402 is the network entity 110 depicted and described with respect to FIG. 1, the network entity 300 or 302 depicted and described with respect to FIG. 3, or a disaggregated base station depicted and described with respect to FIG. 2.

The RACH procedure 400a may optionally begin at 406, where the network entity 402 broadcasts and the UE 404 receives a random access configuration. The random access configuration may be referred to herein as a PRACH configuration. The network entity 402 may broadcast the random access configuration, for example, in system information (SI) via an SSB, or via an RRC message. The random access configuration may indicate or include one or more parameters for random access communications, such as defining the RACH, the total number of random access preambles (for example, preamble sequences) available for random access, power ramping parameters, and/or a response window size.

At 408, the UE 404 sends a first message (MSG1) to the network entity 402 on a PRACH. In some cases, a PRACH may be referred to as a RACH. In certain aspects, MSG1 may indicate or include a RACH preamble. The RACH preamble may be or include a preamble sequence (for example, a Zadoff Chu sequence). For contention-based random access, the preamble sequence may be randomly selected among a set of preamble sequences (for example, up to 64 sequences, in some cases). The preamble sequence may be used to identify the UE 404 for scheduling communications (for example, MSG2 and MSG3) with the network entity. In certain aspects, terms such as “RACH preamble,” “random access preamble,” “preamble,” “preamble sequence,” “sequence,” and the like may be used interchangeably.

At 410, the network entity 402 may respond with a random access response (RAR) message (MSG2). For example, the network entity 402 may send a PDCCH communication including downlink control information (DCI) that schedules the RAR on the PDSCH. The RAR may include, for example, certain parameters used for an uplink transmission such as a random access (RA) preamble identifier (RAPID), a timing advance, an uplink (UL) grant (for example, indicating one or more time-frequency resources for an uplink transmission), cell radio network temporary identifier (C-RNTI), and/or a backoff parameter value. The RAPID may correspond to the preamble sequence and indicate that the RAR is for the UE 404 that transmitted MSG1 at 406. The backoff parameter value may be used to determine a PRACH occasion for sending a subsequent RACH transmission (for example, a preamble transmission). A PRACH occasion may correspond to one or more time-frequency resources available for transmitting a preamble in a RACH.

At 412, in response to MSG2, the UE 404 transmits a third message (MSG3) to the network entity 402 on the PUSCH. In some aspects, MSG3 may include an RRC connection request, a tracking area update (for UE mobility), and/or a scheduling request (for an UL transmission). As an example, MSG3 is communicated in the time-frequency resource(s) indicated in the UL grant of the RAR.

At 414, the network entity 402 may send a contention resolution message (MSG4) in response to MSG3. The network entity 402 may send a downlink scheduling command (for example, DCI), which is addressed to a specific UE identity associated with the UE 404, via the PDCCH. The network entity 402 may send a UE contention resolution identity (for example, in a medium access control element) via the PDSCH according to the downlink scheduling command. In certain cases, multiple UEs may send the same preamble in the same PRACH occasion. Because the network entity 402 may not be able to identify which UE sent which preamble, the network entity 402 may reply with a single RAR associated with the preamble. The MSG3 may include or indicate a specific UE identity associated with the UE 404, such as a radio network temporary identifier (RNTI) or a temporary mobile subscriber identity (TMSI). The network entity 402 may decode MSG3 and determine the UE identity associated with at least one of the UEs (for example, UE 404). MSG4 may be addressed to the UE identity (for example the RNTI or an RNTI based on the TMSI) associated with the MSG3 that the network entity was able to successfully decode. For example, the MSG4 may be scrambled by the RNTI associated with the MSG3. If the UE 404 obtains the same identity sent in MSG3, the UE 404 concludes that the random access procedure succeeded. In some cases, if the UE 404 is unable to obtain or decode MSG3 and/or MSG4, the UE 404 may repeat the RACH procedure, such as the four-step RACH procedure 400a.

In some cases, to reduce the latency associated with random access, a two-step RACH procedure may be used. The two-step RACH procedure may effectively consolidate the four messages of the four-step RACH procedure into two messages.

FIG. 4B depicts a process flow diagram of an example two-step RACH procedure 400b performed between the UE 404 and the network entity 402.

The procedure 400b may optionally begin at 450, where the network entity 402 broadcasts and the UE 404 receives a random access configuration, for example in system information within an SSB, or in an RRC message.

At 452, the UE 404 sends a first message (MSGA) to the network entity 402, which may effectively combine MSG1 and MSG3 described above with respect to FIG. 4A. In some aspects, MSGA includes a RACH preamble for random access and a payload. For example, the payload may include a UE-ID and other signaling information, such as a buffer status report or scheduling request. The RACH preamble of MSGA may be transmitted over the PRACH, and the payload of MSGA may be transmitted over the PUSCH, for example.

At 454, the network entity 402 may send a random access response message (MSGB), which may effectively combine MSG2 and MSG4 described above, via the PDCCH and PDSCH. For example, MSGB may include a RAPID, a timing advance, a backoff parameter value, a contention resolution message, an uplink and/or downlink grant, and a transmit power control command.

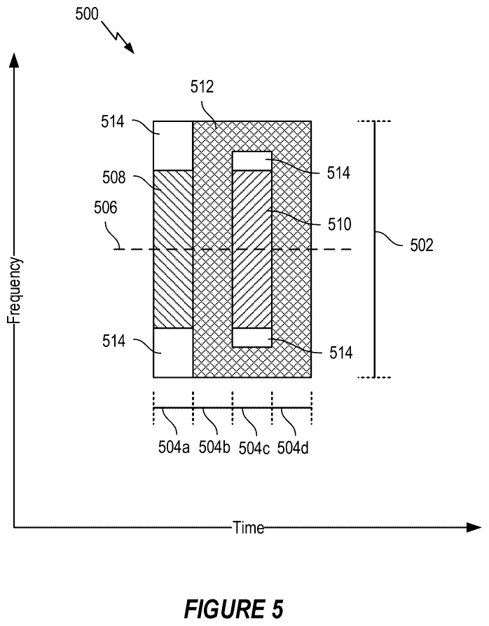

FIG. 5 illustrates an example SSB 500. In this example, the SSB 500 occupies 20 resource blocks in the frequency domain (illustrated at 502) and 4 symbols 504a-d (collectively referred to as “symbols 504”) in the time domain. The SSB 500 may have a center frequency 506 that corresponds to a global synchronization channel number (GSCN) and a frequency position (denoted SSREF) according to an SSB synchronization raster, such as the synchronization raster provided in Table 1.

TABLE 1
GSCN parameters for the global frequency raster

| Range of | SSB frequency | | |
|---|---|---|---|
| frequencies | position | | Range of |
| (MHz) | SS_{REF} | GSCN | GSCN |
| 0-3000 | N * 1200 kHz + | 3N + | 2-7498 |
| | M * 50 kHz, | (M − 3)/2 | |
| | N = 1:2499, | | |
| | M ϵ {1, 3, 5} | | |
| 3000-24250 | 3000 MHz + N * | 7499 + N | 7499-22255 |
| | 1.44 MHz, | | |
| | N = 0:14756 | | |
| 24250-100000 | 24250.8 MHz + N * | 22256 + N | 22256-26639 |
| | 17.28 MHz, | | |
| | N = 0:4383 | | |

The SSB 500 may include a primary synchronization signal (PSS) 508, a secondary synchronization signal (SSS) 510, and a physical broadcast channel (PBCH) 512. In some aspects, the PSS 508 occupies a first portion of the resource blocks 502 (in some examples, 127 subcarriers) in the first symbol 504a. In some aspects, the SSS 510 occupies the first portion of the resource blocks 502 (in some examples, 127 subcarriers) in the third symbol 504c. In some aspects, the PBCH 512 occupies the resource blocks 502 in the second symbol 504b and the fourth symbol 504d, and a second portion of the resource blocks 502 (in some examples, 8 resource blocks) in the fourth symbol 504c. Thus, there may be empty time-frequency resources 514 arranged in the first symbol 504a and the third symbol 504c.

Note that the SSB 500 is merely an example structure for synchronization signaling, and other structures (for example, different time and/or frequency domain arrangements for the PSS, SSS, and/or PBCH) may be used in addition to or instead of the structure depicted for the SSB 500.

In some cases, synchronization signaling may be conveyed via a discovery reference signal having one or more synchronization signals, such as a PSS, a SSS, and/or a tertiary SS (TSS). In certain cases, some synchronization signaling may not have the PBCH.

A UE may use the PSS 508 and the SSS 510 for time and frequency synchronization for wireless communications with a network entity. As discussed herein, the PBCH 512 may carry certain system information (e.g., the MIB) that enables a UE to communicate with the network entity. For example, the MIB may indicate a location of a CORESET #0. The CORESET #0 may carry a RMSI PDCCH, and the RMSI PDCCH may carry downlink control information that schedules an RMSI PDSCH carrying further system information.

RMSI (including the RMSI PDCCH and the RMSI PDSCH) may be periodically broadcasted, for example, based on an SSB multiplexing pattern. For example, the RMSI may be broadcasted every 160 ms. A first SSB multiplexing pattern may provide for the RMSI to be time division multiplexed (TDMed) with the SSB 500, and may be usable for FR1 and FR2. A second SSB multiplexing pattern may provide for the RMSI to be frequency division multiplexed (FDMed) with the SSB 500, and may be usable for FR2. For example, the RMSI PDSCH may be FDMed with the SSB 500, and the RMSI PDCCH may be adjacent to the RMSI PDSCH in the time domain and occupy the same frequency resources as the RMSI PDSCH. A third SSB multiplexing pattern may provide for the RMSI (both the RMSI PDCCH and the RMSI PDSCH) to be FDMed with the SSB, and may be usable for FR2.

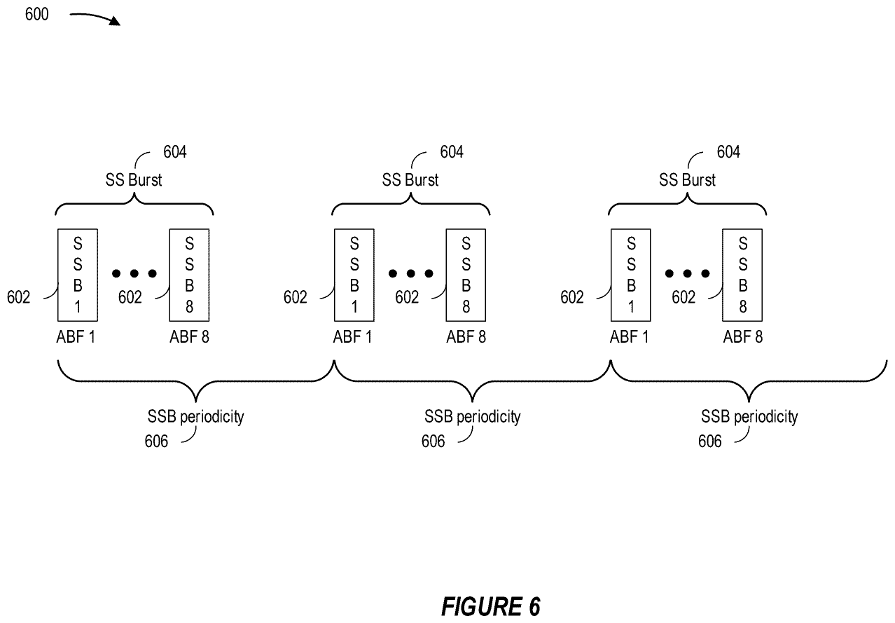

FIG. 6 is a diagram illustrating an example 600 of TDMed SSBs 602 belonging to SS bursts 604a, 604b, and 604c. In FIG. 6, the horizontal axis denotes time. An SSB 602 may be an example of SSB 500. In example 600, the SSBs 602 are each associated with a respective analog beamforming (ABF) configuration, such as a respective set of amplitudes and/or phases. As shown, each SS burst 604 includes 8 SSBs 602 and has a periodicity 606, which in example 600 is 20 ms. The second through seventh SSBs of each SS burst 604 are not illustrated. In some aspects, an SS burst 604 may include a different number of SSBs 602 and/or may have a different periodicity. In some aspects, an SS burst 604 has a length of 5 ms, though other lengths can be configured for an SS burst 604. Each of the 8 SSBs 602 is associated with a respective ABF configuration, denoted “ABF 1” through “ABF 8.” Thus, in FIG. 6, different SSBs 602 are transmitted with beamsweeping according to different ABF configurations. Introducing beamsweeping for digital precoders, in addition to the beamsweeping for the ABF configurations, in only the time domain, would introduce latency and reduce the number of digital precoders that can be measured and selected from by a UE.

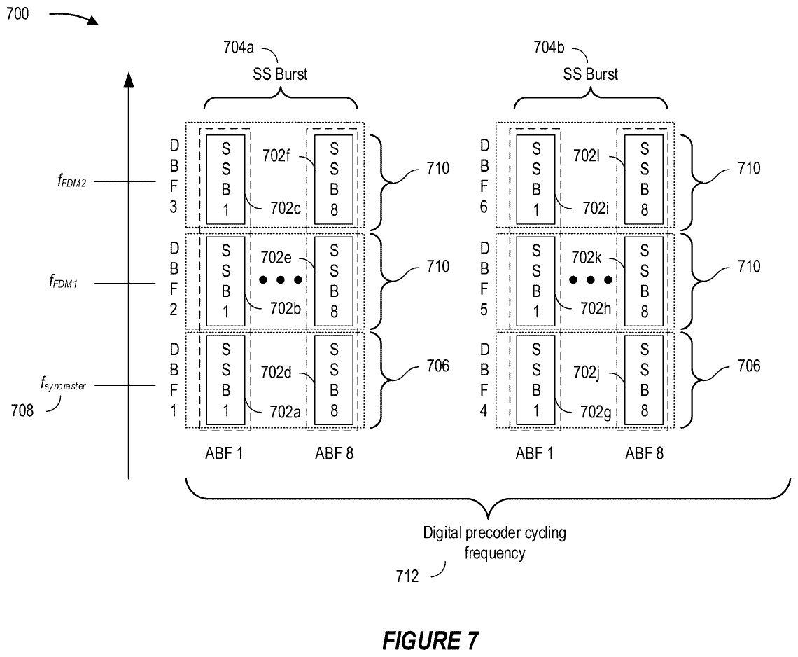

FIG. 7 is a diagram illustrating an example 700 of TDMed and FDMed SSBs 702 belonging to SS bursts 704a and 704b. In FIG. 7, the horizontal axis denotes time and the vertical axis denotes frequency. An SSB 702 may be an example of SSB 500. In example 700, the SSBs 702 are each associated with a respective digital precoder (denoted digital beamforming (DBF) configuration). For example, each SSB 702 may be transmitted using a respective digital precoder.

Generally, aspects described herein are described with respect to first SSB and one or more second SSBs. A first SSB may be a reference SSB. A first SSB may be transmitted according to a synchronization raster. For example, in FIG. 7, SSBs 702 denoted by reference number 706 are first SSBs, and are transmitted at a frequency 708 defined by the synchronization raster (denoted f_{syncraster}). Second SSBs may be FDMed with the first SSB or otherwise offset in frequency from the first SSB. In FIG. 7, SSBs 702 denoted by reference number 710 are second SSBs. In some aspects, second SSBs corresponding to a first SSB may be transmitted using a same ABF configuration as the first SSB. In example 700, the second SSBs denoted by reference number 710 occur at frequencies denoted f_{FDM1} and f_{FDM2}, which are different than f_{syncraster} and one another. The number of second SSBs associated with a given first SSB can be greater than or equal to 1.

In example 700, SSB 702a is a first SSB transmitted with a first ABF configuration and a first digital precoder (denoted “DBF 1”), SSB 702b is a second SSB transmitted with the first ABF configuration and a second digital precoder (denoted “DBF 2”), and SSB 702c is a second SSB transmitted with the first ABF configuration and a third digital precoder (denoted “DBF 3”). SSB 702d is a first SSB transmitted with an eighth ABF configuration and the first digital precoder (SSBs transmitted with the second through seventh ABF configurations are not illustrated), SSB 702e is a second SSB transmitted with the eighth ABF configuration and the second digital precoder, and SSB 702f is a second SSB transmitted with the eighth ABF configuration and the third digital precoder. Each of SSBs 702a-702f are part of a same SS burst 704a.

SSB 702g is a first SSB transmitted with the first ABF configuration and a fourth digital precoder (denoted “DBF 4”), SSB 702h is a second SSB transmitted with the first ABF configuration and a fifth digital precoder (denoted “DBF 5”), and SSB 702i is a second SSB transmitted with the first ABF configuration and a sixth digital precoder (denoted “DBF 6”). SSB 702j is a first SSB transmitted with an eighth ABF configuration and the fourth digital precoder (SSBs transmitted with the second through seventh ABF configurations are not illustrated), SSB 702k is a second SSB transmitted with the eighth ABF configuration and the fifth digital precoder, and SSB 702l is a second SSB transmitted with the eighth ABF configuration and the sixth digital precoder. Each of SSBs 702g-702l are part of a same SS burst 704b.

Thus, a network entity may sweep 6 digital precoders across time and frequency for each SSB 702. In some aspects, the network entity may perform this beamsweeping in a frequency-first, time-second order, as illustrated (for example, digital precoders may be incremented across frequency in each of the SS burst 604a and 604b, a first set of digital precoders may be used in the first SS burst 604a, and a second set of digital precoders are used in the second SS burst 604b). In example 700, two additional SSBs 702 (second SSBs), are FDMed with a reference SSB 702 (first SSB) that is located on the synchronization raster.

In example 700, the digital precoders are cycled in accordance with a periodicity 712. In example 700, the periodicity 712 is 40 ms, corresponding to the length of 2 SS bursts 704. However, any length of periodicity 712 may be used, for example, depending on how many digital precoders are to be beamswept across. Thus, by FDMing SSBs with different digital precoders, digital precoder cycling latency is reduced.

An SSB 702 may include or indicate RMSI, as described with respect to FIG. 5. In some aspects, RMSI of an SSB 702, such as a first SSB (also referred to as a reference SSB or an SSB on a synchronization raster) may indicate frequency-domain locations of one or more second SSBs (such as the SSBs 702 indicated by reference number 710). For example, the RMSI may indicate that a center frequency of one second SSB 702 is located 28 resource blocks (RBs) above a center frequency of the first SSB 702, and a center frequency of another second SSB 702 is located 56 RBs above the center frequency of the first SSB 702.

Additionally or alternatively, the RMSI may indicate a pattern associated with digital precoders of the SSBs 702. For example, the RMSI may indicate a mapping between SSBs 702 and digital precoders (shown as DBF 1 through DBF 6). The mapping may include information such as a number of digital precoders, a length of the periodicity 712, a cycling pattern (such as a frequency-first, time-second cycling pattern as illustrated in FIG. 7, or a time-first, frequency-second cycling pattern), or other information. For example, in FIG. 7, the pattern may indicate 6 digital precoders, a frequency-first, time-second cycling pattern, and a periodicity 712 of 2 SS bursts. The periodicity 712 may be calculated as the number of digital precoders, divided by one plus the number of second SSBs of example 700. In example 700, there are 6 digital precoders and 2 second SSBs 702 FDMed with a given first SSB 702, so the periodicity 712 is (6/(1+2))=2 SS bursts.

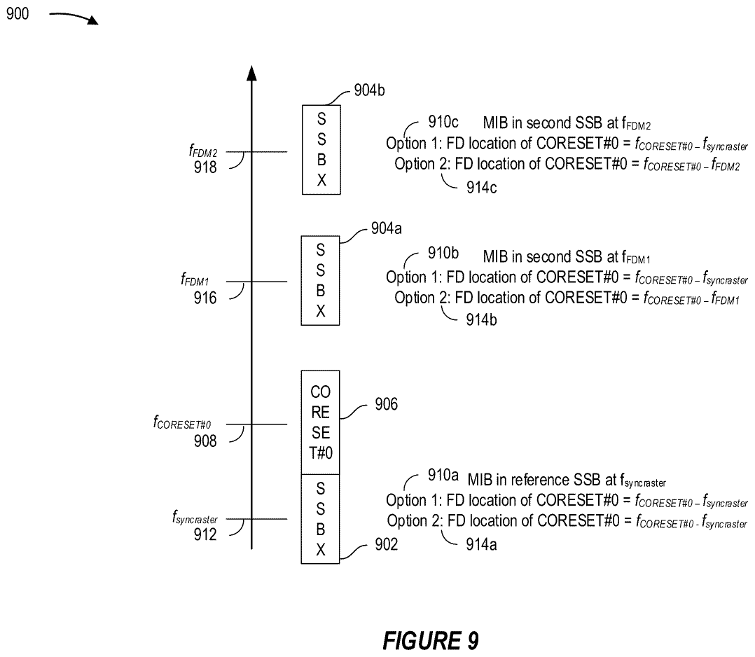

Thus, a UE accessing a cell can first search for a first SSB 702 (a reference SSB) on the synchronization raster. Upon finding the first SSB 702, the UE can decode a MIB of the first SSB 702, identify a location of CORESET #0 (as described in connection with FIG. 9), and search the CORESET #0 for RMSI that indicates the pattern and/or the frequency-domain locations of the one or more second SSBs 702. The UE can measure the first SSB 702 and the one or more second SSBs 702 to select an appropriate SSB and/or digital precoder (such as an SSB and/or digital precoder associated with a measurement that satisfies a threshold, a best measurement, or a measurement that satisfies another condition).

In some aspects, a PBCH of an SSB 702 (such as PBCH 512) may include an SSB index of the SSB 702 and may identify a digital precoder identifier of the SSB 702. For example, a PBCH of SSB 702a may indicate an SSB index of “SSB 1” and a digital precoder identifier that identifies the first digital precoder, a PBCH of SSB 702b may indicate an SSB index of “SSB 1” and a digital precoder identifier that identifies the second digital precoder, and a PBCH of SSB 702c may indicate an SSB index of “SSB 1” and a digital precoder identifier that identifies the third digital precoder. Thus, the SSBs 702a, 702b, and 702c may all be associated with a same SSB index, and the UE can identify an appropriate digital precoder by measuring the SSBs 702a, 702b, 702c and associating a measurement (such as an SSB reference signal received power (RSRP)) with an SSB index and a digital precoder identifier. In some aspects, though SSBs 702a, 702b, and 702c are referred to as a first SSB and two second SSBs, these may be considered the same SSB since these SSBs are associated with the same SSB index. Thus, a UE may report a selected SSB of “SSB 1” (which may indicate SSB 702a, 702b, and 702c), and a selected digital precoder of one of SSBs 702a, 702b, and 702c.

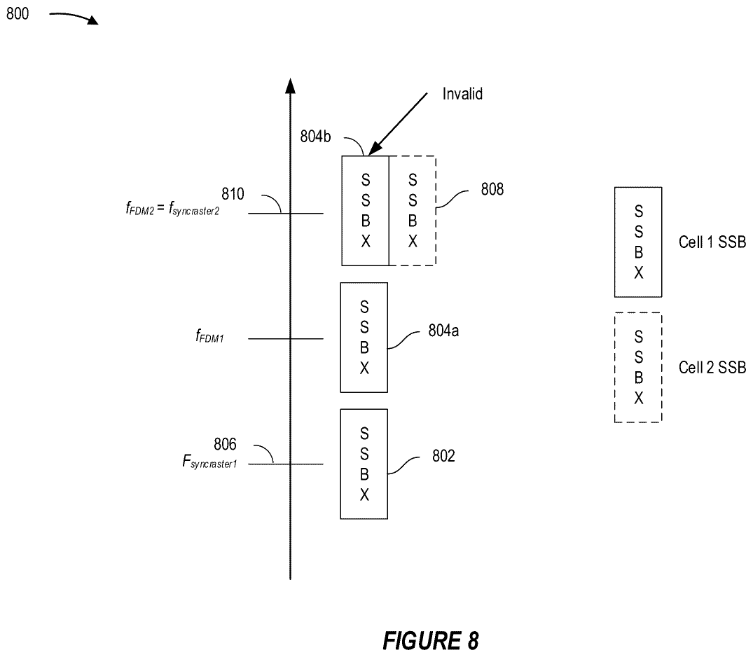

FIG. 8 is a diagram illustrating an example 800 of validity or invalidity of an SSB according to a synchronization raster. Example 800 includes a first SSB 802 (for example, SSB 702 indicated by reference number 706) and two second SSBs 804a and 804b (for example, SSB 702 indicated by reference number 710) that are FDMed with the first SSB 802. The first SSB 802 and the second SSBs 804 are associated with (such as transmitted by) a first cell. The first SSB 802 is a reference SSB of the first cell, and is transmitted on a frequency 806 indicated by a synchronization raster of the first cell. Example 800 also includes a first SSB 808 (for example, SSB 702 indicated by reference number 706), which is a reference SSB of a second cell and is transmitted on a frequency 810 indicated by a synchronization raster of the second cell.

In some aspects, second SSBs may not be permitted to occur on a synchronization raster of any cell. For example, the second SSB 804b may be invalid because a center frequency of the second SSB is on the frequency 810 which is indicated by the synchronization raster of the second cell. As a result, a UE that detects an SSB at the frequency 810 can distinguish a reference SSB (such as the first SSB 808) from a second SSB (such as the SSB 804) by determining whether the SSB is on a synchronization raster. Thus, a situation in which the UE cannot access the second cell due to a second SSB 804 being on the second cell's synchronization raster is avoided.

FIG. 9 is a diagram illustrating an example 900 of indication of a location of a CORESET #0 for FDMed SSBs. As described, a UE may obtain an RMSI PDCCH in CORESET #0, which may indicate the location of an RMSI PDCCH from which the UE may obtain system information for a cell. Traditionally, the location of CORESET #0 has been defined relative to an SSB. Example 900 provides a first option (“Option 1”) and a second option (“Option 2”) for defining the location of CORESET #0 when multiple SSBs are FDMed with each other (such as the first SSBs and second SSBs 702 of example 700).

Example 900 includes a first SSB 902 (for example, SSB 702 indicated by reference number 706) and two second SSBs 904a and 904b (for example, SSB 702 indicated by reference number 710) that are FDMed with the first SSB 902. As shown, the first SSB 902 is associated with a CORESET #0 906. The CORESET #0 906 occurs at a frequency 908, illustrated as “f_{CORESET #0}”. Each SSB 902, 904 includes a respective PBCH (such as PBCH 512, not illustrated), and each PBCH may include a respective MIB (not illustrated).

In Option 1, as indicated by reference number 910a, 910b, and 910c, a MIB may indicate a frequency 908 of CORESET #0 906 relative to a frequency 912 of the first SSB 902. For example, a MIB of any of SSBs 902 and 904 may indicate the frequency 908 relative to the frequency 912 (such as a center frequency) of a reference SSB. As indicated by reference number 910a, 910b, and 910c, a MIB of each of first SSB 902, second SSB 904a, and second SSB 904b may indicate the frequency 908 as a value “f_{CORESET #0} minus f_{syncraster}.” As a result, the content of the MIB is consistent across SSBs 902 and 904.

In Option 2, as indicated by reference number 914a, 914b, and 914c, a MIB may indicate a frequency 908 of CORESET #0 906 relative to a frequency 912, 916, or 918 of the SSB that includes the MIB. For example, as indicated by reference number 914a, a MIB of first SSB 902 may indicate the frequency 908 as a value “f_{CORESET #0} minus f_{syncraster}.” As indicated by reference number 914b, a MIB of second SSB 904a may indicate the frequency 908 as a value “f_{CORESET #0} minus f_{FDM1}.” As indicated by reference number 914c, a MIB of second SSB 904b may indicate the frequency 908 as a value “f_{CORESET #0} minus f_{FDM2}.”

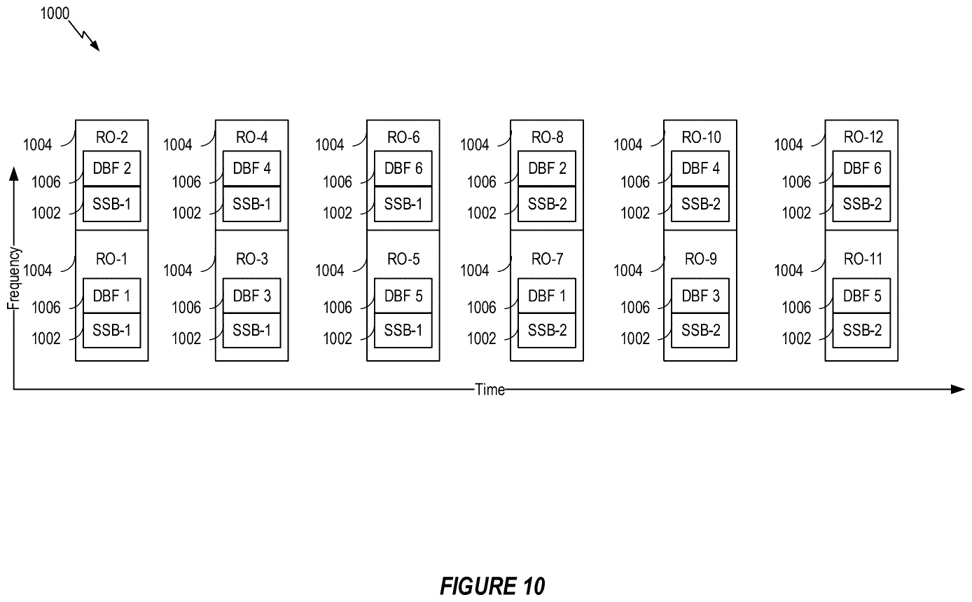

FIG. 10 is a diagram illustrating an example 1000 of SSBs 1002 that are each associated with one or more ROs 1004 and digital precoders 1006. In some aspects, as illustrated, an RO 1004 may be associated with (such as mapped to) an SSB index (associated with an SSB 1002) and a digital precoder 1006. For example, RO-1 is mapped to SSB-1 and a digital precoder 1006 identified as DBF 1. In example 1000, each RO 1004 is mapped to one combination of digital precoder 1006 and SSB 1002.

A UE may transmit an indication of a selected digital precoder 1006 (and a selected SSB 1002) by transmitting a RACH message, such as a RACH MSG1 or a RACH preamble, on a corresponding RO 1004. In some aspects, ROs 1004 that are associated with the same SSB index and different digital precoders 1006 may be multiplexed, such as FDMed or TDMed. For example, these ROs 1004 may be multiplexed in a frequency-first, time-second mapping pattern. Providing the indication of the selected digital precoder 1006 via the RACH MSG1 or RACH preamble may reduce latency and overhead associated with indicating the selected digital precoder 1006.

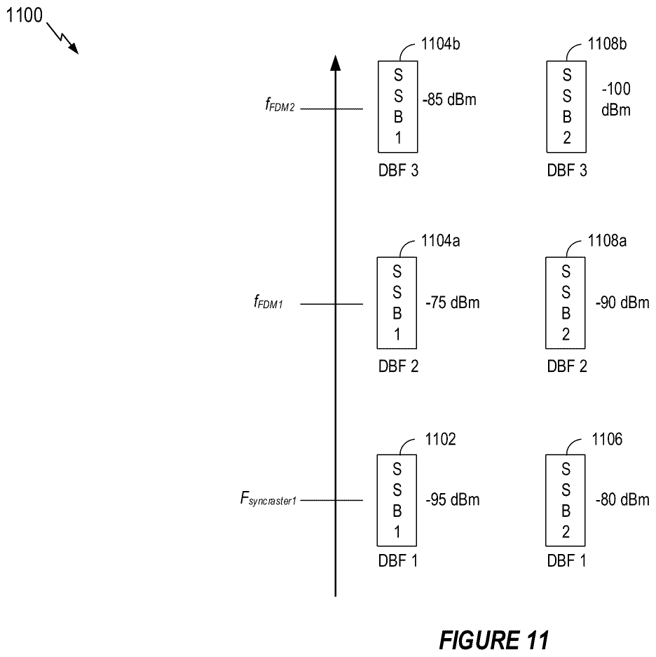

FIG. 11 is a diagram illustrating an example 1100 of measurements on multiple FDMed and TDMed SSBs. Example 1100 includes a first SSB 1102 (for example, SSB 702 indicated by reference number 706) and two second SSBs 1104a and 1104b (for example, SSB 702 indicated by reference number 710) that are FDMed with the first SSB 1102. Example 1100 also includes a first SSB 1106 (for example, SSB 702 indicated by reference number 706) and two second SSBs 1108a and 1108b (for example, SSB 702 indicated by reference number 710) that are FDMed with the first SSB 1102. The first SSB 1106 is TDMed with the first SSB 1102 and the second SSBs 1108a and 1108b are TDMed with the second SSBs 1104a and 1104b, respectively. The first SSBs 1102 and 1106 are associated with a first digital precoder (DBF 1), the second SSBs 1104a and 1108a are associated with a second digital precoder (DBF 2), and the third SSBs 1104b and 1108b are associated with a third digital precoder (DBF 3). The first SSB 1102 is associated with a measurement (RSRP, in this example, though other measurements may be used) of −95 dBm, the first SSB 1106 is associated with a measurement of −80 dBm, the second SSB 1104a is associated with a measurement of −75 dBm, the second SSB 1108a is associated with a measurement of −90 (negative 90) dBm, the second SSB 1104b is associated with a measurement of −85 dBm, and the second SSB 1108b is associated with a measurement of −100 dBm.

Example 1100 relates to how a UE is to determine and report a measurement associated with an SSB 1102/1104/1106/1108, a digital precoder, or a combination thereof. For example, the UE may report such a measurement in connection with SSB RSRP reporting of a neighbor cell, such as in a MeasObjectNR parameter.

In some aspects, the UE may report an RSRP and SSB index of a best reference SSB. In example 1100, first SSBs 1102 and 1106 are reference SSBs. For example, the UE may measure RSRPs of only reference SSBs, and may report information indicating a best SSB index and a corresponding SSB RSRP. In this approach, the UE may measure first SSB 1102 and 1106, and may report an SSB index of “SSB 2” (corresponding to first SSB 1106) and an SSB RSRP of −80 dBm.

In some aspects, the UE may report an RSRP and SSB index, and digital precoder of a best SSB. For example, the UE may measure RSRPs of reference SSBs (such as first SSB 1102 and first SSB 1106) as well as FDMed SSBs (such as second SSBs 1104 and second SSBs 1108), and may report information indicating a best SSB index, a corresponding SSB RSRP, and a digital precoder of the best SSB. In this approach, the UE may measure SSBs 1102, 1104, 1106, 1108. The UE may select second SSB 1104a in accordance with second SSB 1104a having a highest RSRP. The UE may report an SSB index of “SSB 1” (corresponding to second SSB 1104a), a digital precoder of “DBF 2” (corresponding to second SSB 1104a) and an SSB RSRP of −75 dBm for second SSB 1104a. Thus, the UE may measure RSRPs of reference SSBs and FDMed SSBs, and may report an RSRP, SSB index, and digital precoder of a best SSB. Thus, a network entity can use the digital precoder for subsequent communication.

In some aspects, the UE may report an average RSRP and SSB index. For example, the UE may measure RSRPs of reference SSBs (such as first SSB 1102 and first SSB 1106) as well as FDMed SSBs (such as second SSBs 1104 and second SSBs 1108). The UE may determine an average RSRP for a first SSB and corresponding second SSBs. For example, the UE may average the RSRP values of first SSB 1102 and second SSBs 1104a and 1104b to obtain a first average RSRP of −79.32 dBm. The UE may also average the RSRP values of first SSB 1106 and second SSBs 1108a and 1108b to obtain a second average RSRP of −84.32 dBm. Thus, the UE may determine an average SSB RSRP of an SSB (such as SSB 1) by averaging SSB RSRPs across all digital precoders of the SSB. The UE may select an SSB index of a best SSB according to the average RSRPs. For example, the UE may select “SSB 1” (corresponding to SSBs 1102 and 1104). The UE may report the SSB index of SSB 1 and the average RSRP of −79.32 dBm.

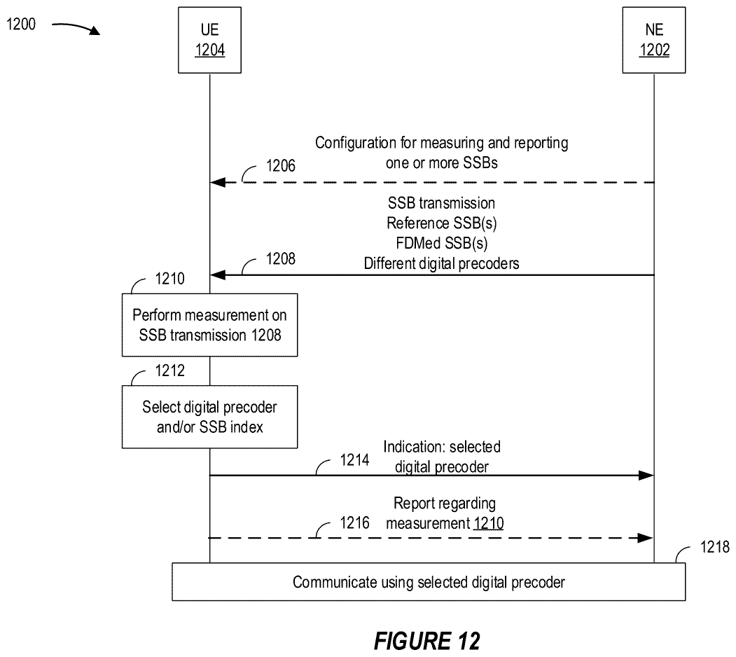

FIG. 12 is a diagram illustrating an example 1200 of signaling for FDMed SSB transmission with multiple digital precoders. Example 1200 includes a network entity 1202 and a UE 1204. In some aspects, the network entity 1202 may be an example of the network entity 110 depicted and described with respect to FIG. 1, the first network entity 300 or the second network entity 302 depicted and described with respect to FIG. 3, or a disaggregated base station depicted and described with respect to FIG. 2. Similarly, the UE 1204 may be an example of UE 120 depicted and described with respect to FIG. 1 or the UE 304 depicted and described with respect to FIG. 3. However, in other aspects, UE 1204 may be another type of wireless communications device and network entity 1202 may be another type of network entity or network node, such as those described herein. Note that any operations or signaling illustrated with dashed lines may indicate that that operation or signaling is an optional or alternative example.

As shown, the network entity 1202 may transmit, and the UE 1204 may receive, an indication of a configuration 1206 for measuring and reporting of one or more SSBs. For example, the configuration 1206 may indicate whether to measure RSRPs of only reference SSBs (such as SSBs 1102 and 1106), or of reference SSBs and FDMed SSBs (such as SSBs 1104 and 1108). In some aspects, the configuration 1206 may indicate whether to report an SSB index and RSRP of a best reference SSB, an SSB index, RSRP, and digital precoder of a best SSB, or an SSB index and average RSRP across all digital precoders associated with the SSB index. In some aspects, the configuration 1206 may indicate a pattern for digital precoders, as described, for example, with regard to FIG. 7.

As shown, the network entity 1202 may transmit, and the UE 1204 may receive, an SSB transmission 1208. The SSB transmission 1208 may include one or more first SSBs (such as SSBs 702 indicated by reference number 706) and one or more second SSBs (such as SSBs 702 indicated by reference number 710). For example, the one or more second SSBs may be FDMed with the one or more first SSBs. In some aspects, the one or more first SSBs and the one or more second SSBs may be part of an SS burst, such as SS burst 704. In some aspects, the SSB transmission 1208 may include multiple SS bursts, such as a first SS burst 704a and a second SS burst 704b. Two or more SSBs of the SSB transmission 1208 may be associated with different digital precoders, as described with regard to FIG. 7. For example, a first SSB of the SSB transmission 1208 may be associated with (such as transmitted using or indicated as mapped to) a first digital precoder and a second SSB of the SSB transmission 1208 may be associated with (such as transmitted using or indicated as mapped to) a second digital precoder different than the first digital precoder. In some aspects, an SSB of a first SS burst and an SSB of a second SS burst may be transmitted with a same digital precoder. For example, in the time domain, the digital precoder may cycle across the SS bursts. In some aspects, the SSB transmission 1208 (such as an RMSI PDSCH of an SSB of the SSB transmission 1208) may indicate a pattern for a digital precoder or a frequency location of one or more second SSBs, as described with regard to FIG. 7.

As shown, the UE 1204 may perform a measurement 1210 on the SSB transmission 1208. For example, the UE 1204 may measure only reference SSBs (such as SSBs on a synchronization raster, for example, SSBs 702a, 702d, 1102, 1106). As another example, the UE 1204 may measure reference SSBs as well as FDMed SSBs (for example, SSBs 702b, 702c, 702e, 702f, 1104, 1108). In some aspects, the measurement may be an RSRP measurement. In some aspects, the UE 1204 may average the measurement across SSBs associated with a given SSB index (such as for all digital precoders.

As shown, in an operation 1212, the UE 1204 may select one or more of an SSB or a digital precoder. For example, the UE 1204 may select the SSB or the digital precoder in accordance with the measurements. In some aspects, the UE may select an SSB index, for example, according to an RSRP of a reference SSB having the SSB index or an average RSRP across all SSBs (and digital precoders) having the SSB index. In some aspects, the UE may select an SSB index and digital precoder, for example, according to an RSRP of an SSB (which may be a reference SSB or an FDMed SSB) associated with the SSB index and the digital precoder.

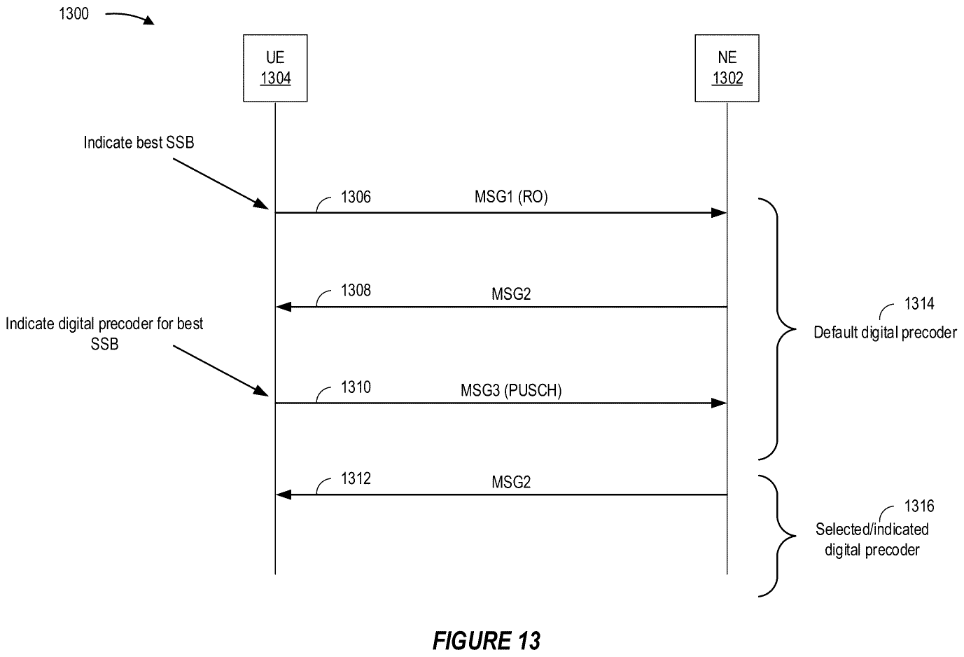

As shown, the UE 1204 may transmit, and the network entity 1202 may receive, an indication 1214 of the selected digital precoder. In some aspects, the indication 1214 may comprise a RACH message, such as a RACH preamble (for example, RACH MSG1) on an RO associated with the selected digital precoder or a RACH PUSCH (for example, RACH MSG3) identifying the selected digital precoder. This is described in more detail in connection with FIG. 13.

As shown, in some aspects, the UE 1204 may transmit, and the network entity 1202 or another network entity may receive, a report 1216 regarding the measurement 1210. For example, the UE 1204 may transmit the report 1216 in association with cell measurement for mobility. In this case, the UE 1204 may transmit the report 1216 to a serving cell of the UE 1204, and the SSB transmission 1208 may be from a neighboring cell of the UE 1204. For example, the UE 1204 may transmit a report 1216 including a MeasObjectNR parameter. The UE may report one or more of an SSB RSRP (such as an SSB RSRP of an individual SSB or an averaged SSB RSRP), an SSB index, or a digital precoder, as described in connection with FIG. 12. Thus, ambiguity regarding how to report SSB RSRPs (and optionally digital precoders) for FDMed SSBs with different digital precoders is resolved.

As shown, in an operation 1218, the UE 1204 and the network entity 1202 may communicate using the selected digital precoder. For example, the network entity 1202 may perform a downlink transmission using the digital precoder (such as by applying the digital precoder for the downlink transmission). In some aspects, the UE 1204 may use a beam associated with the selected digital precoder.

FIG. 13 is a diagram illustrating an example 1300 of indication of a selected digital precoder during a RACH procedure. Example 1300 includes a network entity 1302 and a UE 1304. In some aspects, the network entity 1302 may be an example of the network entity 110 depicted and described with respect to FIG. 1, the first network entity 300 or the second network entity 302 depicted and described with respect to FIG. 3, or a disaggregated base station depicted and described with respect to FIG. 2. Similarly, the UE 1304 may be an example of UE 120 depicted and described with respect to FIG. 1 or the UE 304 depicted and described with respect to FIG. 3. However, in other aspects, UE 1304 may be another type of wireless communications device and network entity 1302 may be another type of network entity or network node, such as those described herein. Note that any operations or signaling illustrated with dashed lines may indicate that that operation or signaling is an optional or alternative example.

Example 1300 includes a RACH preamble transmission 1306 (for example, a MSG1, as described at 408), a RACH MSG2 1308 (as described at 410), a RACH PUSCH transmission 1310 (for example, a MSG3, as described at 412), and a RACH MSG4 1312 (as described at 414). The UE 1304 may indicate a selected SSB (such as a best SSB) by transmitting the RACH preamble transmission 1306 on an RO associated with the selected SSB, as described with regard to FIG. 10. Thus, after the network entity 1302 receives the RACH preamble transmission 1306, the network entity 1302 can communicate with the UE 1304 using a beam associated with the selected SSB.

In example 1300, the UE 1304 reports a selected digital precoder via the RACH PUSCH transmission 1310. For example, the RACH PUSCH transmission 1310 may include information that identifies the selected digital precoder. Thus, as illustrated at 1314, in example 1300, the network entity 1302 may use a default digital precoder, which in some examples may be suboptimal for the UE. At 1314, after receiving the report of the selected digital precoder (which may be an example of the indication 1214), the network entity 1302 may use the selected digital precoder, which may provide improved performance for communications between the UE 1304 and the network entity 1302.

In some other examples, the UE 1304 reports a selected digital precoder via the RACH preamble transmission 1306. For example, the RO on which the RACH preamble transmission 1306 is performed may be associated with the selected digital precoder, as described with regard to FIG. 10. In this example, the network entity 1302 may use the selected digital precoder for RACH MSG2 1308 and RACH MSG4 1312 (as well as for subsequent communications), thereby improving communication performance of the RACH MSG2 1308 and RACH MSG4 1312.

In some aspects, the UE 1304 may report a selected digital precoder via a MSGA of a two-step RACH procedure, such as by selecting an RO associated with the selected digital precoder or indicating the selected digital precoder in a PUSCH of the MSGA.

FIG. 14 shows a process 1400 for wireless communications by an apparatus, such as UE 120 of FIG. 1 or UE 304 of FIG. 3.

Process 1400 begins at block 1405 with receiving a SSB transmission that includes a first SSB associated with a first digital precoder and a second SSB, at least partially overlapped in time with the first SSB, associated with a second digital precoder.

Process 1400 then proceeds to block 1410 with performing a measurement on the SSB transmission.

Process 1400 then proceeds to block 1415 with transmitting an indication of a selected digital precoder of the first digital precoder or the second digital precoder, wherein the selected digital precoder is in accordance with the measurement.

In some aspects, the first SSB is frequency division multiplexed with the second SSB.

In some aspects, the first SSB belongs to a first SS burst, and wherein the process 1400 further comprises receiving a second SS burst that includes a third SSB associated with the second digital precoder.

In some aspects, process 1400 further includes receiving remaining minimum system information that indicates a frequency location of the second SSB.

In some aspects, process 1400 further includes receiving remaining minimum system information that indicates a pattern associated with the first digital precoder and the second digital precoder.

In some aspects, process 1400 further includes identifying, in accordance with receiving the first SSB, a control resource set that contains RMSI, wherein the measurement is according to the RMSI.

In some aspects, process 1400 further includes selecting the selected digital precoder according to the measurement.

In some aspects, the second SSB includes a PBCH that indicates the second digital precoder.

In some aspects, a frequency location of the second SSB is non-overlapped with any frequency location of an SSB synchronization raster associated with the first SSB.

In some aspects, the first SSB is a reference SSB and a CORESET #0 of a cell associated with the first SSB is multiplexed with the first SSB in at least one of time or frequency.

In some aspects, the first SSB and the second SSB each include a PBCH that includes a MIB that indicates a location of the CORESET #0 relative to the first SSB.

In some aspects, the first SSB includes a first PBCH that includes a first MIB and the second SSB includes a second PBCH that includes a second MIB, wherein the first MIB indicates a location of the CORESET #0 relative to the first SSB and the second MIB indicates a location of the CORESET #0 relative to the second SSB.

In some aspects, the indication of the selected digital precoder comprises a RACH message that includes a PUSCH message.

In some aspects, the indication of the selected digital precoder comprises a RACH message on a RACH occasion associated with the selected digital precoder.

In some aspects, the first SSB is one of a plurality of reference SSBs, and the process 1400 further comprises reporting a reference signal received power and SSB index of a best reference SSB of the plurality of reference SSBs.

In some aspects, the first SSB is one of a plurality of reference SSBs, and the process 1400 further comprises reporting a reference signal received power, SSB index, and digital precoder of a best SSB of the plurality of reference SSBs and the second SSB.

In some aspects, the first SSB is one of a plurality of reference SSBs, and the process 1400 further comprises reporting: a best SSB index of a plurality of SSB indices respectively associated with the plurality of reference SSBs, and an average reference signal received power of the plurality of reference SSBs and the second SSB.

In some aspects, process 1400 further includes receiving an indication of a configuration for measuring and reporting a reference signal received power based on the first SSB and the second SSB, wherein at least one of the measurement or the transmission of the indication of the selected digital precoder is in accordance with the indication of the configuration.

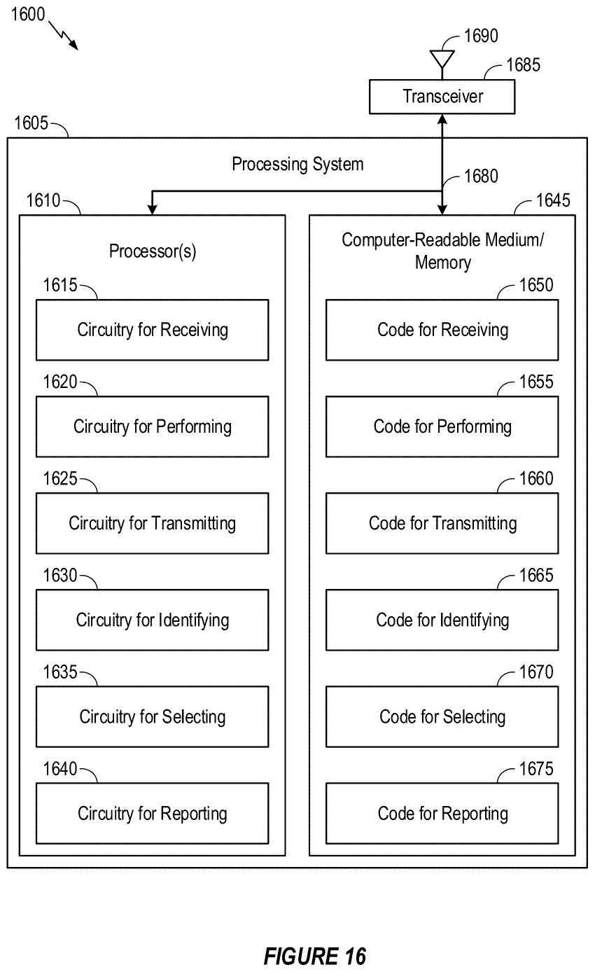

In some aspect, process 1400, or any aspect related to it, may be performed by an apparatus, such as communications device 1600 of FIG. 16, which includes various components operable, configured, or adapted to perform the process 1400. Communications device 1600 is described below in further detail.

Note that FIG. 14 is just one example of a method, and other methods including fewer, additional, or alternative operations are possible consistent with this disclosure.

FIG. 15 shows a process 1500 for wireless communications by an apparatus, such as network entity 110 of FIG. 1, a first network entity 300 or second network entity 302 of FIG. 3, or a disaggregated base station as discussed with respect to FIG. 2.

Process 1500 begins at block 1505 with transmitting a SSB transmission that includes a first SSB associated with a first digital precoder and a second SSB, at least partially overlapped in time with the first SSB, associated with a second digital precoder.

Process 1500 then proceeds to block 1510 with receiving an indication of a selected digital precoder of the first digital precoder or the second digital precoder.

Process 1500 then proceeds to block 1515 with communicating using the selected digital precoder.

In some aspects, the first SSB is frequency division multiplexed with the second SSB.

In some aspects, the first SSB belongs to a first SS burst, and wherein the process 1500 further comprises transmitting a second SS burst that includes a third SSB associated with the second digital precoder.

In certain aspects, process 1500 further includes transmitting remaining minimum system information that indicates a frequency location of the second SSB.

In certain aspects, process 1500 further includes transmitting remaining minimum system information that indicates a pattern associated with the first digital precoder and the second digital precoder.

In some aspects, the second SSB includes a PBCH that indicates the second digital precoder.

In some aspects, a frequency location of the second SSB is non-overlapped with any frequency location of an SSB synchronization raster associated with the first SSB.

In some aspects, the first SSB is a reference SSB and a CORESET #0 of a cell associated with the first SSB is multiplexed with the first SSB in at least one of time or frequency.

In some aspects, the first SSB and the second SSB each include a PBCH that includes a MIB that indicates a location of the CORESET #0 relative to the first SSB.

In some aspects, the first SSB includes a first PBCH that includes a first MIB and the second SSB includes a second PBCH that includes a second MIB, wherein the first MIB indicates a location of the CORESET #0 relative to the first SSB and the second MIB indicates a location of the CORESET #0 relative to the second SSB.

In some aspects, the indication is included in a RACH message that comprises a PUSCH message.

In some aspects, the indication is included in a RACH message that comprises a RACH preamble on a RACH occasion associated with the selected digital precoder.

In some aspects, the first SSB is one of a plurality of reference SSBs, and the process 1500 further comprises receiving a reference signal received power and SSB index of a best reference SSB of the plurality of reference SSBs.

In some aspects, the first SSB is one of a plurality of reference SSBs, and the process 1500 further comprises receiving a reference signal received power, SSB index, and digital precoder of a best SSB of the plurality of reference SSBs and the second SSB.

In some aspects, the first SSB is one of a plurality of reference SSBs, and the process 1500 further comprises receiving: a best SSB index of a plurality of SSB indices respectively associated with the plurality of reference SSBs, and an average reference signal received power of the plurality of reference SSBs and the second SSB.

In certain aspects, process 1500 further includes transmitting an indication of a configuration for measuring and reporting a reference signal received power based on the first SSB and the second SSB.

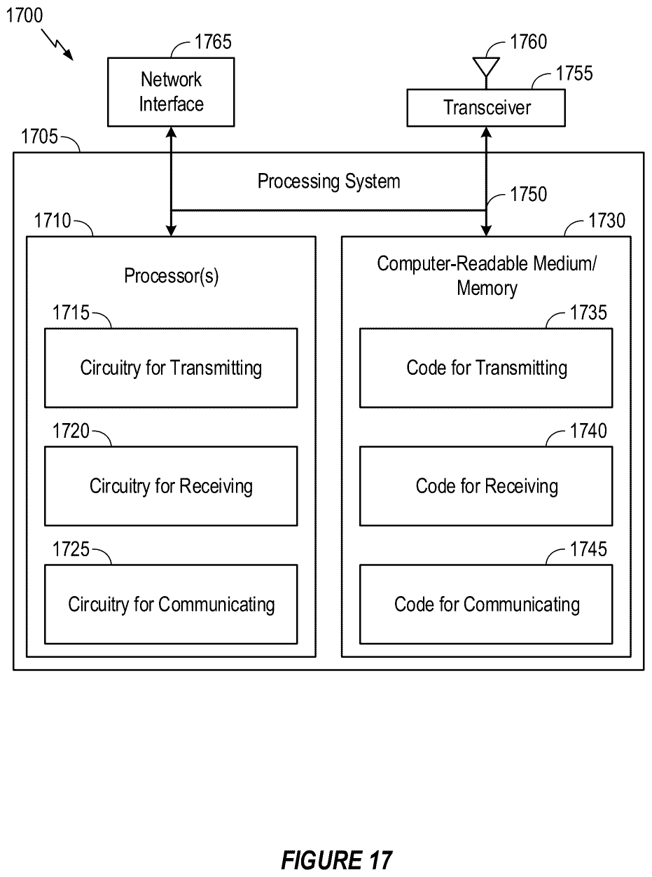

In some aspect, process 1500, or any aspect related to it, may be performed by an apparatus, such as communications device 1700 of FIG. 17, which includes various components operable, configured, or adapted to perform the process 1500. Communications device 1700 is described below in further detail.

Note that FIG. 15 is just one example of a method, and other methods including fewer, additional, or alternative operations are possible consistent with this disclosure.

FIG. 16 depicts aspects of an example communications device 1600 configured for wireless communications. In some aspects, communications device 1600 is a user equipment, such as UE 120 described above with respect to FIG. 1 or UE 304 described with respect to FIG. 3.

The communications device 1600 includes a processing system 1605 coupled to a transceiver 1685 (e.g., a transmitter and/or a receiver). The transceiver 1685 is configured to transmit and receive signals for the communications device 1600 via an antenna 1690, such as the various signals as described herein. The processing system 1605 may be configured to perform processing functions for the communications device 1600, including processing signals received and/or to be transmitted by the communications device 1600.

The processing system 1605 includes one or more processors 1610 and a computer-readable medium/memory 1645. In various aspects, the one or more processors 1610 may be representative of the one or more processors 318 described with respect to FIG. 3. The one or more processors 1610 are coupled to a computer-readable medium/memory 1645 via a bus 1680. In some aspects, the computer-readable medium/memory 1645 may be representative of the one or more memories 320 described with respect to FIG. 3. The computer-readable medium/memory 1645 is a non-transitory computer-readable medium/memory. In certain aspects, the computer-readable medium/memory 1645 is configured to store instructions (e.g., computer-executable code), that when executed by the one or more processors 1610, cause the one or more processors 1610 to perform the process 1400 described with respect to FIG. 14, or any aspect related to it, including any operations described in relation to FIG. 14. Note that reference to a processor performing a function of communications device 1600 may include one or more processors performing that function of communications device 1600, such as in a distributed fashion.

In the depicted example, computer-readable medium/memory 1645 stores code (e.g., executable instructions), including code for receiving 1650, code for performing 1655, code for transmitting 1660, code for identifying 1665, code for selecting 1670, and code for reporting 1675. Processing of the code 1650-1675 may enable and cause the communications device 1600 to perform the process 1400 described with respect to FIG. 14, or any aspect related to it.

The one or more processors 1610 include circuitry configured to implement (e.g., execute) the code stored in the computer-readable medium/memory 1645, including circuitry for receiving 1615, circuitry for performing 1620, circuitry for transmitting 1625, circuitry for identifying 1630, circuitry for selecting 1635, and circuitry for reporting 1640. Processing with circuitry 1615-1640 may enable and cause the communications device 1600 to perform the process 1400 described with respect to FIG. 14, or any aspect related to it.

More generally, means for communicating, transmitting, sending or outputting for transmission may include the one or more transceivers 324, one or more antenna 322 and/or processing system 316 of the UE 304 illustrated in FIG. 3, transceiver 1685 and/or antenna 1690 of the communications device 1600 in FIG. 16, and/or one or more processors 1610 of the communications device 1600 in FIG. 16. Means for communicating, receiving or obtaining may include the one or more transceivers 324, one or more antennas 322, and/or processing system 316 of the UE 304 illustrated in FIG. 3, transceiver 1685 and/or antenna 1690 of the communications device 1600 in FIG. 16, and/or one or more processors 1610 of the communications device 1600 in FIG. 16.

FIG. 17 depicts aspects of an example communications device configured for wireless communications. In some aspects, communications device 1700 is a network entity, such as network entity 110 of FIG. 1, first network entity 300 or second network entity 302 of FIG. 3, or a disaggregated base station as discussed with respect to FIG. 2.

The communications device 1700 includes a processing system 1705 coupled to a transceiver 1755 (e.g., a transmitter and/or a receiver) and/or a network interface 1765. The transceiver 1755 is configured to transmit and receive signals for the communications device 1700 via an antenna 1760, such as the various signals as described herein. The network interface 1765 is configured to obtain and send signals for the communications device 1700 via communications link(s), such as a backhaul link, midhaul link, and/or fronthaul link as described herein, such as with respect to FIG. 2. The processing system 1705 may be configured to perform processing functions for the communications device 1700, including processing signals received and/or to be transmitted by the communications device 1700.

The processing system 1705 includes one or more processors 1710 and a computer-readable medium/memory 1730. In various aspects, one or more processors 1710 may be representative of the one or more processors 308, as described with respect to FIG. 3. The one or more processors 1710 are coupled to the computer-readable medium/memory 1730 via a bus 1750. In certain aspects, the computer-readable medium/memory 1730 is configured to store instructions (e.g., computer-executable code), including code 1735-1745, that when executed by the one or more processors 1710, cause the one or more processors 1710 to perform the process 1500 described with respect to FIG. 15, or any aspect related to it, including any operations described in relation to FIG. 15. The computer-readable medium/memory 1730 is a non-transitory computer-readable medium/memory. Note that reference to a processor of communications device 1700 performing a function may include one or more processors of communications device 1700 performing that function, such as in a distributed fashion.

In the depicted example, the computer-readable medium/memory 1730 stores code (e.g., executable instructions), including code for transmitting 1735, code for receiving 1740, and code for communicating 1745. Processing of the code 1735-1745 may enable and cause the communications device 1700 to perform the process 1500 described with respect to FIG. 15, or any aspect related to it.

The one or more processors 1710 include circuitry configured to implement (e.g., execute) the code stored in the computer-readable medium/memory 1730, including circuitry for transmitting 1715, circuitry for receiving 1720, and circuitry for communicating 1725. Processing with circuitry 1715-1725 may enable and cause the communications device 1700 to perform the process 1500 described with respect to FIG. 15, or any aspect related to it.

Various components of the communications device 1700 may provide means for performing the process 1500 described with respect to FIG. 15, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1755, antenna 1760, and/or network interface 1765 of the communications device 1700 in FIG. 17, and/or one or more processors 1710 of the communications device 1700 in FIG. 17. Means for communicating, receiving or obtaining may include the one or more transceivers 312, one or more antennas 314, and/or processing system 306 of the first network entity 300 or the second network entity 302 illustrated in FIG. 3, transceiver 1755, antenna 1760, and/or network interface 1765 of the communications device 1700 in FIG. 17, and/or one or more processors 1710 of the communications device 1700 in FIG. 17.

Implementation examples are described in the following numbered clauses:

Clause 1: A method for wireless communications by a UE comprising: receiving a SSB transmission that includes a first SSB associated with a first digital precoder and a second SSB, at least partially overlapped in time with the first SSB, associated with a second digital precoder; performing a measurement on the SSB transmission; and transmitting an indication of a selected digital precoder of the first digital precoder or the second digital precoder, wherein the selected digital precoder is in accordance with the measurement.

Clause 2: The method of Clause 1, wherein the first SSB is frequency division multiplexed with the second SSB.

Clause 3: The method of any one of Clauses 1-2, wherein the first SSB belongs to a first SS burst, and wherein the method further comprises receiving a second SS burst that includes a third SSB associated with the second digital precoder.

Clause 4: The method of any one of Clauses 1-3, further comprising receiving remaining minimum system information that indicates a frequency location of the second SSB.

Clause 5: The method of any one of Clauses 1-4, further comprising receiving remaining minimum system information that indicates a pattern associated with the first digital precoder and the second digital precoder.

Clause 6: The method of any one of Clauses 1-5, further comprising: identifying, in accordance with receiving the first SSB, a control resource set that contains RMSI, wherein the measurement is according to the RMSI; and selecting the selected digital precoder according to the measurement.

Clause 7: The method of any one of Clauses 1-6, wherein the second SSB includes a PBCH that indicates the second digital precoder.

Clause 8: The method of any one of Clauses 1-7, wherein a frequency location of the second SSB is non-overlapped with any frequency location of an SSB synchronization raster associated with the first SSB.

Clause 9: The method of any one of Clauses 1-8, wherein the first SSB is a reference SSB and a CORESET #0 of a cell associated with the first SSB is multiplexed with the first SSB in at least one of time or frequency.

Clause 10: The method of Clause 9, wherein the first SSB and the second SSB each include a PBCH that includes a MIB that indicates a location of the CORESET #0 relative to the first SSB.

Clause 11: The method of Clause 9, wherein the first SSB includes a first PBCH that includes a first MIB and the second SSB includes a second PBCH that includes a second MIB, wherein the first MIB indicates a location of the CORESET #0 relative to the first SSB and the second MIB indicates a location of the CORESET #0 relative to the second SSB.

Clause 12: The method of any one of Clauses 1-11, wherein the indication of the selected digital precoder comprises a RACH message that includes a PUSCH message.

Clause 13: The method of any one of Clauses 1-12, wherein the indication of the selected digital precoder comprises a RACH message on a RACH occasion associated with the selected digital precoder.

Clause 14: The method of any one of Clauses 1-13, wherein the first SSB is one of a plurality of reference SSBs, and the method further comprises reporting a reference signal received power and SSB index of a best reference SSB of the plurality of reference SSBs.

Clause 15: The method of any one of Clauses 1-14, wherein the first SSB is one of a plurality of reference SSBs, and the method further comprises reporting a reference signal received power, SSB index, and digital precoder of a best SSB of the plurality of reference SSBs and the second SSB.

Clause 16: The method of any one of Clauses 1-15, wherein the first SSB is one of a plurality of reference SSBs, and the method further comprises reporting: a best SSB index of a plurality of SSB indices respectively associated with the plurality of reference SSBs, and an average reference signal received power of the plurality of reference SSBs and the second SSB.

Clause 17: The method of any one of Clauses 1-16, further comprising receiving an indication of a configuration for measuring and reporting a reference signal received power based on the first SSB and the second SSB, wherein at least one of the measurement or the transmission of the indication of the selected digital precoder is in accordance with the indication of the configuration.

Clause 18: A method for wireless communications by a network entity comprising: transmitting a SSB transmission that includes a first SSB associated with a first digital precoder and a second SSB, at least partially overlapped in time with the first SSB, associated with a second digital precoder; receiving an indication of a selected digital precoder of the first digital precoder or the second digital precoder; and communicating using the selected digital precoder.

Clause 19: The method of Clause 18, wherein the first SSB is frequency division multiplexed with the second SSB.

Clause 20: The method of any one of Clauses 18-19, wherein the first SSB belongs to a first SS burst, and wherein the method further comprises transmitting a second SS burst that includes a third SSB associated with the second digital precoder.

Clause 21: The method of any one of Clauses 18-20, further comprising transmitting remaining minimum system information that indicates a frequency location of the second SSB.

Clause 22: The method of any one of Clauses 18-21, further comprising transmitting remaining minimum system information that indicates a pattern associated with the first digital precoder and the second digital precoder.

Clause 23: The method of any one of Clauses 18-22, wherein the second SSB includes a PBCH that indicates the second digital precoder.

Clause 24: The method of any one of Clauses 18-23, wherein a frequency location of the second SSB is non-overlapped with any frequency location of an SSB synchronization raster associated with the first SSB.

Clause 25: The method of any one of Clauses 18-24, wherein the first SSB is a reference SSB and a CORESET #0 of a cell associated with the first SSB is multiplexed with the first SSB in at least one of time or frequency.

Clause 26: The method of Clause 25, wherein the first SSB and the second SSB each include a PBCH that includes a MIB that indicates a location of the CORESET #0 relative to the first SSB.

Clause 27: The method of Clause 25, wherein the first SSB includes a first PBCH that includes a first MIB and the second SSB includes a second PBCH that includes a second MIB, wherein the first MIB indicates a location of the CORESET #0 relative to the first SSB and the second MIB indicates a location of the CORESET #0 relative to the second SSB.

Clause 28: The method of any one of Clauses 18-27, wherein the indication is included in a RACH message that comprises a PUSCH message.

Clause 29: The method of any one of Clauses 18-28, wherein the indication is included in a RACH message that comprises a RACH preamble on a RACH occasion associated with the selected digital precoder.

Clause 30: The method of any one of Clauses 18-29, wherein the first SSB is one of a plurality of reference SSBs, and the method further comprises receiving a reference signal received power and SSB index of a best reference SSB of the plurality of reference SSBs.

Clause 31: The method of any one of Clauses 18-30, wherein the first SSB is one of a plurality of reference SSBs, and the method further comprises receiving a reference signal received power, SSB index, and digital precoder of a best SSB of the plurality of reference SSBs and the second SSB.

Clause 32: The method of any one of Clauses 18-31, wherein the first SSB is one of a plurality of reference SSBs, and the method further comprises receiving: a best SSB index of a plurality of SSB indices respectively associated with the plurality of reference SSBs, and an average reference signal received power of the plurality of reference SSBs and the second SSB.

Clause 33: The method of any one of Clauses 18-32, further comprising transmitting an indication of a configuration for measuring and reporting a reference signal received power based on the first SSB and the second SSB.

Clause 34: One or more apparatuses, comprising: one or more memories comprising executable instructions; and one or more processors configured to execute the executable instructions and cause the one or more apparatuses to perform a method in accordance with any one of Clauses 1-33.

Clause 35: One or more apparatuses configured for wireless communications, comprising: one or more memories; and one or more processors, coupled to the one or more memories, configured to cause the one or more apparatuses to perform a method in accordance with any one of Clauses 1-33.

Clause 36: One or more apparatuses configured for wireless communications, comprising: one or more memories; and one or more processors, coupled to the one or more memories, configured to perform a method in accordance with any one of Clauses 1-33.

Clause 37: One or more apparatuses, comprising means for performing a method in accordance with any one of Clauses 1-33.

Clause 38: One or more non-transitory computer-readable media comprising executable instructions that, when executed by one or more processors of one or more apparatuses, cause the one or more apparatuses to perform a method in accordance with any one of Clauses 1-33.

Clause 39: One or more computer program products embodied on one or more computer-readable storage media comprising code for performing a method in accordance with any one of Clauses 1-33.

Clause 40: One or more apparatuses configured for wireless communications, comprising: a processing system that includes one or more processors and one or more memories coupled with the one or more processors, the processing system configured to cause the one or more apparatuses to perform a method in accordance with any one of Clauses 1-33.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communications, the apparatus comprising a processing system that includes one or more processors and one or more memories coupled with the one or more processors, the processing system configured to cause a user equipment (UE) to:
receive a synchronization signal block (SSB) transmission that includes a first SSB associated with a first digital precoder and a second SSB, at least partially overlapped in time with the first SSB, associated with a second digital precoder;
perform a measurement on the SSB transmission; and
transmit an indication of a selected digital precoder of the first digital precoder or the second digital precoder, wherein the selected digital precoder is in accordance with the measurement.

2. The apparatus of claim 1, wherein the first SSB is frequency division multiplexed with the second SSB.

3. The apparatus of claim 1, wherein the first SSB belongs to a first synchronization signal (SS) burst, and wherein the processing system is further configured to cause the UE to receive a second SS burst that includes a third SSB associated with the second digital precoder.

4. The apparatus of claim 1, wherein the processing system is further configured to cause the UE to receive remaining minimum system information that indicates a frequency location of the second SSB.

5. The apparatus of claim 1, wherein the processing system is further configured to cause the UE to receive remaining minimum system information that indicates a pattern associated with the first digital precoder and the second digital precoder.

6. The apparatus of claim 1, wherein the processing system is further configured to cause the UE to:
identify, in accordance with receiving the first SSB, a control resource set that contains remaining minimum system information (RMSI), wherein the measurement is according to the RMSI; and
select the selected digital precoder according to the measurement.

7. The apparatus of claim 1, wherein the second SSB includes a physical broadcast channel (PBCH) that indicates the second digital precoder.

8. The apparatus of claim 1, wherein a frequency location of the second SSB is non-overlapped with any frequency location of an SSB synchronization raster associated with the first SSB.

9. The apparatus of claim 1, wherein the first SSB is a reference SSB and a control resource set zero (CORESET #0) of a cell associated with the first SSB is multiplexed with the first SSB in at least one of time or frequency.

10. The apparatus of claim 9, wherein the first SSB and the second SSB each include a physical broadcast channel (PBCH) that includes a master information block (MIB) that indicates a location of the CORESET #0 relative to the first SSB.

11. The apparatus of claim 9, wherein the first SSB includes a first physical broadcast channel (PBCH) that includes a first master information block (MIB) and the second SSB includes a second PBCH that includes a second MIB, wherein the first MIB indicates a location of the CORESET #0 relative to the first SSB and the second MIB indicates a location of the CORESET #0 relative to the second SSB.

12. The apparatus of claim 1, wherein the indication of the selected digital precoder comprises a random access channel (RACH) message that includes a physical uplink shared channel (PUSCH) message.

13. The apparatus of claim 1, wherein the indication of the selected digital precoder comprises a random access channel (RACH) message on a RACH occasion associated with the selected digital precoder.

14. The apparatus of claim 1, wherein the first SSB is one of a plurality of reference SSBs, and the processing system is configured to cause the UE to report a reference signal received power and SSB index of a best reference SSB of the plurality of reference SSBs.

15. The apparatus of claim 1, wherein the first SSB is one of a plurality of reference SSBs, and the processing system is configured to cause the UE to report a reference signal received power, SSB index, and digital precoder of a best SSB of the plurality of reference SSBs and the second SSB.

16. The apparatus of claim 1, wherein the first SSB is one of a plurality of reference SSBs, and the processing system is configured to cause the UE to report:
a best SSB index of a plurality of SSB indices respectively associated with the plurality of reference SSBs, and
an average reference signal received power of the plurality of reference SSBs and the second SSB.

17. The apparatus of claim 1, wherein the processing system is configured to cause the UE to receive an indication of a configuration for measuring and reporting a reference signal received power based on the first SSB and the second SSB, wherein at least one of the measurement or the transmission of the indication of the selected digital precoder is in accordance with the indication of the configuration.

18. An apparatus for wireless communications, the apparatus comprising a processing system that includes one or more processors and one or more memories coupled with the one or more processors, the processing system configured to cause a network entity to:
transmit a synchronization signal block (SSB) transmission that includes a first SSB associated with a first digital precoder and a second SSB, at least partially overlapped in time with the first SSB, associated with a second digital precoder;
receive an indication of a selected digital precoder of the first digital precoder or the second digital precoder; and
communicate using the selected digital precoder.

19. The apparatus of claim 18, wherein the first SSB is frequency division multiplexed with the second SSB.

20. The apparatus of claim 18, wherein a frequency location of the second SSB is non-overlapped with any frequency location of an SSB synchronization raster.

21. The apparatus of claim 18, wherein the first SSB is a reference SSB and a control resource set zero (CORESET #0) of a cell associated with the first SSB is multiplexed with the first SSB in at least one of time or frequency.

22. The apparatus of claim 21, wherein the first SSB includes a first physical broadcast channel (PBCH) that includes a first master information block (MIB) and the second SSB includes a second PBCH that includes a second MIB, wherein the first MIB indicates a location of the CORESET #0 relative to the first SSB and the second MIB indicates a location of the CORESET #0 relative to the second SSB.

23. The apparatus of claim 18, wherein the indication is included in a random access channel (RACH) message that comprises a physical uplink shared channel (PUSCH) message.

24. The apparatus of claim 18, wherein the indication is included in a random access channel (RACH) message that comprises a RACH preamble on a RACH occasion associated with the selected digital precoder.

25. The apparatus of claim 18, wherein the processing system is configured to cause the network entity to transmit an indication of a configuration for measuring and reporting a reference signal received power based on the first SSB and the second SSB.

26. A method for wireless communications by a user equipment (UE) comprising:
receiving a synchronization signal block (SSB) transmission that includes a first SSB associated with a first digital precoder and a second SSB, at least partially overlapped in time with the first SSB, associated with a second digital precoder;
performing a measurement on the SSB transmission; and
transmitting an indication of a selected digital precoder of the first digital precoder or the second digital precoder, wherein the selected digital precoder is in accordance with the measurement.

27. The method of claim 26, wherein the first SSB is frequency division multiplexed with the second SSB.

28. The method of claim 26, wherein the first SSB belongs to a first synchronization signal (SS) burst, and wherein the method further comprises receiving a second SS burst that includes a third SSB associated with the second digital precoder.

29. A method for wireless communications by a network entity comprising:
transmitting a synchronization signal block (SSB) transmission that includes a first SSB associated with a first digital precoder and a second SSB, at least partially overlapped in time with the first SSB, associated with a second digital precoder;
receiving an indication of a selected digital precoder of the first digital precoder or the second digital precoder; and
communicating using the selected digital precoder.

30. The method of claim 29, wherein the first SSB is frequency division multiplexed with the second SSB.
